(19) United States
(12) Patent Application Publication
(10) Pub. No.: US 2014/0278303 A1
(43) Pub. Date: Sep. 18, 2014

(54) METHOD AND SYSTEM OF DYNAMIC MODEL IDENTIFICATION FOR MONITORING AND CONTROL OF DYNAMIC MACHINES WITH VARIABLE STRUCTURE OR VARIABLE OPERATION CONDITIONS

(71) Applicant: Wallace LARIMORE, McLean, VA (US)

(72) Inventor: Wallace LARIMORE, McLean, VA (US)

(21) Appl. No.: 14/217,838

(22) Filed: Mar. 18, 2014

Related U.S. Application Data
(60) Provisional application No. 61/787,246, filed on Mar. 15, 2013.

(51) Int. Cl. G06F 17/50

(52) U.S. Cl. CPC G06F 17/5018; G06F 17/5095
USPC 703/2

(57) ABSTRACT

A method and system for identification of nonlinear parameter-varying systems via canonical variate analysis. Various implementations of these methods and systems may be implemented on various platforms and may include and of a variety of applications and physical implementations.

### BACKGROUND

The modeling of nonlinear and time-varying dynamic processes or systems from measured output data and possibly input data is an emerging area of technology. Depending on the area of theory or application, it may be called time series analysis in statistics, system identification in engineering, longitudinal analysis in psychology, and forecasting in financial analysis.

In the past there has been the innovation of subspace system identification methods and considerable development and refinement including optimal methods for systems involving feedback, exploration of methods for nonlinear systems including bilinear systems and linear parameter varying (LPV) systems. Subspace methods can avoid iterative nonlinear parameter optimization that may not converge, and use numerically stable methods of considerable value for high order large scale systems.

In the area of time-varying and nonlinear systems there has been work undertaken, albeit without the desired results. The work undertaken was typical of the present state of the art in that rather direct extensions of linear subspace methods are used for modeling nonlinear systems. This approach expresses the past and future as linear combinations of nonlinear functions of past inputs and outputs. One consequence of such an approach is that the dimension of the past and future expand exponentially in the number of measured inputs, outputs, states, and lags of the past that are used. When using only a few of each of these variables, the dimension of the past can number over 10⁴ or even more than 10⁶. For typical industrial processes, the dimension of the past can easily exceed 10⁹ or even 10¹². Such extreme numbers result in inefficient exploitation and results, at best.

Other techniques use an iterative subspace approach to estimating the nonlinear terms in the model and as a result require very modest computation. The iterative approach involves a heuristic algorithm, and has been used for high accuracy model identification in the case of LPV systems with a random scheduling function, i.e. with white noise characteristics. One of the problems, however, is that in most LPV systems the scheduling function is usually determined by the particular application, and is often very non-random in character. In several modifications that have been implemented to attempt to improve the accuracy for the case of nonrandom scheduling functions, the result is that the attempted modifications did not succeed in substantially improving the modeling accuracy.

In a more general context, the general problem of identification of nonlinear systems is known as a general nonlinear canonical variate analysis (CVA) procedure. The problem was illustrated with the Lorenz attractor, a chaotic nonlinear system described by a simple nonlinear difference equation. Thus nonlinear functions of the past and future are determined to describe the state of the process that is, in turn used to express the nonlinear state equations for the system. One major difficulty in this approach is to find a feasible computational implementation since the number of required nonlinear functions of past and future expand exponentially as is well known. This difficulty has often been encountered in finding a solution to the system identification problem that applies to general nonlinear systems.

Thus, in some exemplary embodiments described below, methods and systems may be described that can achieve considerable improvement and also produce optimal results in the case where a ‘large sample’ of observations is available. In addition, the method is not ‘ad hoc’ but can involve optimal statistical methods.

### SUMMARY

A method and system for identification of nonlinear parameter-varying systems via canonical variate analysis. Various implementations of these methods and systems may be implemented on various platforms and may include a variety of applications and physical implementations.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary diagram showing the steps in transforming the machine data to a state space dynamic model of the machine.

FIG. 2 is an exemplary diagram showing the steps in the CVA-(N)LPV Realization Method.

FIG. 3 is an exemplary diagram showing the advantages of a Machine Dynamic Model verses the Machine Data.

FIG. 4 is an exemplary diagram showing an aircraft velocity profile used as an input for identification.

FIG. 5 is an exemplary diagram showing a pitch-plunge state-space model order selection using AIC, no noise case and where the true order is 4.

FIG. 6 is an exemplary diagram showing a detailed view of pitch-plunge state-space model order selection showing increasing AIC beyond a minimum at order 4, in a no noise case.

FIG. 7 is an exemplary diagram showing an LPV state-space model 20 step ahead prediction of plunge versus an observed output, in a no noise case.

FIG. 8 is an exemplary diagram showing an LPV state-space model 20 step ahead prediction of plunge versus an observed output, in a no noise case.

FIG. 9 is an exemplary diagram showing a pitch-plunge state-space model order selection using AIC, with measurement noise case.

FIG. 10 is an exemplary diagram showing a view of the pitch-plunge state-space model order selection with increasing AIC beyond minimum at order 6, with measurement noise case.

FIG. 11 is an exemplary diagram showing an LPV state-space model 20 step ahead prediction of plunge versus the observed output, with measurement noise case.

FIG. 12 is an exemplary diagram showing an LPV state-space model 20 step ahead prediction of pitch versus the observed output, with measurement noise case.

FIG. 13 is an exemplary diagram showing an LPV system identification of a delay compensated intake manifold and fuel injection models.

### DESCRIPTION OF INVENTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation. Further, absolute terms, such as “need”, “require”, “must”, and the like shall be interpreted as non-limiting and used for exemplary purposes only.

Further, many of the embodiments described herein are described in terms of sequences of actions to be performed by, for example, elements of a computing device. It should be recognized by those skilled in the art that the various sequence of actions described herein can be performed by specific circuits (e.g., Application Specific Integrated Circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described actions.

The following materials, included herein as non-limiting examples, describe some exemplary embodiments of a method and system for identification of nonlinear parameter-varying systems via canonical variate analysis. Additionally, a further exemplary embodiment describing subspace identification of an aircraft linear parameter-varying flutter model may be described. Additionally, all of these exemplary embodiments included references, cited herein, which are incorporated by reference in their entirety. Various implementations of these methods and systems may be implemented on various platforms and may include a variety of applications and physical implementations.

Generally referring to FIGS. 1-13, it may be desirable to parameterize machine dynamics using parameters of machine structure and operating conditions that are directly measured, such as combustion engine speed in revolutions per minute (RPM) or aircraft speed and altitude. This data may be collected in any of a variety of fashions. For example, any desired probes or sensors may be used to collect and transmit data to a database, where it may be compared and analyzed. For example, using such data, a dynamic model that is parameterized over machine structures and operating conditions. In general, the structure and/or operating point parameters can vary, even varying rapidly, which may not affect the dynamic model, but which can present a more difficult mathematical problem to solve. The results of such a mathematical problem, however, can apply to a broad range of variable structure machines and/or changing constant conditions. Such an approach, as utilized herein, can have an advantage over prior slowly changing “constant” models because those models fail to get measurements at every set of points in a parameterized space and cannot provide information at points other than those which a machine under analysis actual visits or encounters. The exemplary embodiments described herein can provide a highly accurate mathematically valid interpolation method and system.

In one exemplary embodiment, a general method and system for obtaining a dynamic model from a set of data which may include outputs and inputs together with machine structure and operation conditions may be referred to as a realization method or algorithm. It may further be viewed as a transformation on observed data about the machine state and operating condition to a dynamic model describing the machine behavior that can entail various combinations of machine structure, operating conditions, past outputs and inputs, and any resulting future outputs so as to be able to predict future behavior with some fidelity. In a linear time-invariant (LTI) case where there may only be one machine structure and a fixed operating condition, the problem may be reliably solved using subspace system identification methods using singular value decomposition (SVD) methods.

In other situations, a more general problem involving machines with variable structure and variable operating conditions may only involve very small scale problems, sometimes involving extensions of subspace methods. One problem may be that the computational requirements may grow exponentially with the problem size, for example the number of system inputs, outputs, state variables, and operating parameters, so as to exclude the solution of many current practical problems for which solutions are desired. Therefore, in one exemplary embodiment described herein, a realization method and system with computation requirements that may grow only as the cube of a size of a problem may be utilized, for example, similar to an LTI case used on large scale problems.

In such embodiments, a detailed modeling of the dynamics of machines with variable structure and variable operating conditions may be achieved. Such detailed dynamic models may, in turn, allow for analysis of the dynamic structure, construction of estimators and filters, monitoring and diagnosis of system changes and faults, and construction of global controllers for controlling and modifying the behavior of these machines. Thus, exemplary embodiments described herein can transform a set of data from a dynamic machine that often contains substantial noise to an augmented machine with dynamic behavior that can be precisely quantified. This can allow for an accurate estimation of otherwise noisy variables, the ability to monitor the dynamics for changes and faults, and the ability to change the dynamic behavior using advanced control methods. Further, such exemplary embodiments can transform machine data by characterizing its dynamic behavior and then using such information to enable it with a collection of distinctly different functions, for example estimation, filtering, monitoring, failure detection, and control. Exemplary applications of embodiments described herein may be with combustion engines, distillation processes, and/or supersonic transport that can involve very specific and observable natural phenomena as embodied in the measured data of outputs and possibly inputs, along with data describing the variation of machine structure and operating conditions.

Further embodiments described herein can give examples of a canonical variate analysis (CVA) method of subspace system identification for linear time-invariant (LTI), linear parameter-varying (LPV), and nonlinear parameter-varying (NLPV) systems. The embodiments described herein can take a first principles statistical approach to rank determination of deterministic vectors using a singular value decomposition (SVD), followed by a statistical multivariate CVA as rank constrained regression. This can then be generalized to LTI dynamic systems, and extended directly to LPV and NLPV. The computational structure and problem size may be similar to LTI subspace methods except that the matrix row dimension (number of lagged variables of the past) can be multiplied by the effective number of parameter-varying functions. This is in contrast with the exponential explosion in the number of variables using current subspace methods for LPV systems. Compared with current methods, results using the embodiments described herein indicate much less computation, maximum likelihood accuracy, and better numerical stability. The method and system apply to systems with feedback, and can automatically remove a number of redundancies in the nonlinear models producing near minimal state orders and polynomial degrees by hypothesis testing.

The identification of these systems can involve either nonlinear iterative optimization methods with possible problems of local minima and numerical ill-conditioning, or involves subspace methods with exponentially growing computations and associated growing numerical inaccuracy as problem size increases linearly in state dimension. There has been considerable clarification of static and dynamic dependence in transformations between model forms that plays a major role in the CVA identification of LPV and nonlinear models.

The new methods and systems described herein are called CVA-LPV because of their close relationship to the subspace CVA method for LTI systems. As is well known, the solution of the LPV system identification problem can provide a gateway to much more complex nonlinear systems including bilinear systems, polynomial systems, and systems involving any known nonlinear functions of known variables or operating conditions, often called scheduling functions, that are in affine (additive) form.

Referring now to exemplary FIGS. 1-3, the methods and systems described herein may be performed in a variety of steps. For example, in FIG. 1, a transformation from machine data to a machine dynamic model may be shown. First, machine data may be collected and variables assigned in 100. An input-output (N)ARX-LPV dynamic model to machine data may be fitted in 102. Then, in 104, a CVA-(N)LPV realization method may be utilized (as further described with respect to exemplary FIG. 2). Then, in 106, State Space—(N)LPV dynamic model construction may take place. In exemplary FIG. 2, a CVA-(N)LPV realization method may be described. This can include computing a corrected future, performing a CVA, sorting stating estimates and computing an AIC. These elements are described in more detail below. Then, in exemplary FIG. 3, some exemplary advantages of a machine dynamic model versus machine data may be shown. Some exemplary advantages include the machine dynamic model's near optimal accuracy, having a number of estimated parameters near an optimal number corresponding to a true model order for large samples, having a model accuracy RMS that is proportional to a number of estimated parameters, that the CVA has a minimum variance in the presence of feedback for large samples, a rank selection using CVA and AIC that approaches an optimal order, the accuracy of subsequent monitoring, filtering, and control procedures, and the ability of the dynamic model to enable the direct implementation of high accuracy analysis of dynamics, filtering of noisy dynamic variables, accurate moitoring and fault detection, and high accuracy control or modification of the machine dynamic response characteristics.

CVA-LPV is a fundamental statistical approach using maximum likelihood methods for subspace identification of both LPV and nonlinear systems. For the LPV and nonlinear cases, this leads to direct estimation of the parameters using singular value decomposition type methods that avoid iterative nonlinear parameter optimization and the computational requirements grow linearly with problem size as in the LTI case. The results are statistically optimal maximum likelihood parameter estimates and likelihood ratio hypotheses tests on model structure, model change, and process faults produce optimal decisions. As described herein, comparisons are made between different system identification methods. These include the CVA-LPV subspace method, prior subspace methods, and iterative parameter optimization methods such as prediction error and maximum likelihood. Also discussed is the Akaike information criterion (AIC) that is fundamental to hypothesis testing in comparing multiple model structures for a dynamic system.

In some exemplary embodiments, the CVA method is applied to the identification of linear time-invariant (LTI) dynamic systems. Although the theory described above may only apply to iid multivariate vectors, it has been extended to correlated vector time series.

A concept in the CVA approach is the past and future of a process. For example, suppose that data are given consisting of observed outputs yₜ and observed inputs uₜ at time points labeled t=1, . . . , N that are equal spaced in time. Associated with each time t is a past vector pₜ which can be made of the past outputs and inputs occurring prior to time t, a vector of future outputs fₜ which can be made of outputs at time t or later, and future inputs qₜ which can be made of inputs at time t or later, specifically:

pₜ=[yₜ₋₁;uₜ₋₁;yₜ₋₂;uₜ₋₂; . . . ], Equation 1

fₜ=[yₜ;yₜ₊₁; . . . ],qₜ=[uₜ;uₜ₊₁; . . . ]. Equation 2

For dynamic input-output systems with possible stochastic disturbances, one desire is characterizing the input to output properties of the system. A concern is statistical inference about the unknown parameters θ of the probability density

p(Y|U,P;pₗ₊₁θ)

of the outputs Y=y₁^{N} conditional on the inputs U=u₁^{N} and some initial conditions p₁^{l}=[y₁^{l};u₁^{l}].

Therefore, in this example, suppose that the number of samples N is exactly N=Ml+2l for some integer M. By expressing Yₗ₊₁^{Ml+2l}=[f_{Ml+1}, . . . ,f₂ₗ₊₁,fₗ₊₁] and by successively conditioning using Bayes rule, the log likelihood function of the outputs Y conditional on the initial state pₗ₊₁ at time l+1 and the inputs Q is:

$$log p ( \begin{matrix}{y}_{𝓁 + 1}^{M 𝓁 + 2 𝓁} \vert {p}_{𝓁 + 1} , \\ Q , θ\end{matrix} ) = log p ( [ {f}_{M 𝓁 + 1} , … , {f}_{2 𝓁 + 1} , {f}_{𝓁 + 1} ] \vert {p}_{𝓁 + 1} , Q , θ ) = log [ \begin{matrix}p ( {f}_{M 𝓁 + 1} \vert [ \begin{matrix}{f}_{( M - 1 ) 𝓁 + 1} , … , \\ {f}_{2 𝓁 + 1} , {f}_{𝓁 + 1}\end{matrix} ] \vert {p}_{𝓁 + 1} , Q , θ ) p \\ ( [ {f}_{( M - 1 ) 𝓁 + 1} , … , {f}_{2 𝓁 + 1} , {f}_{𝓁 + 1} ] \vert {p}_{𝓁 + 1} , Q , θ )\end{matrix} ] = {\sum }_{m = 0}^{M - 1} log p ( {f}_{m 𝓁 + 𝓁 + 1} \vert {p}_{m 𝓁 + 𝓁 + 1} , Q , θ ) \qquad Equation 5$$

where Q=Q₁^{Ml+l}, so the likelihood function decomposes into the product of M multistep conditional probabilities. Next, by shifting the interval of the observations in the above by time s, the likelihood of the observations Yₗ₊₁₊ₛ^{Ml+2l+s} is obtained. Consider the average of these shifted log likelihood functions which gives:

$$\begin{matrix}\frac{1}{𝓁} {\sum }_{s = 0}^{𝓁 - 1} log p ( {Y}_{𝓁 + 1 + s}^{M 𝓁 + 2 𝓁 + s} \vert {p}_{𝓁 + 1 + s} , Q , θ ) & Equation 6 \\ = \frac{1}{𝓁} {\sum }_{s = 0}^{𝓁 - 1} {\sum }_{m = 0}^{M - 1} log p ( {f}_{m 𝓁 + 𝓁 + 1 + s} \vert {p}_{m 𝓁 + 𝓁 + 1 + s} , Q , θ ) & Equation 7 \\ = \frac{1}{𝓁} {\sum }_{t = 𝓁 + 1}^{N} log p ( ( {f}_{t} \vert {q}_{t} ) \vert {p}_{t} , θ ) ) & Equation 8\end{matrix}$$

Now each likelihood function in this average is a likelihood of N−l points that differs only on the particular end points included in the time interval. This effect will disappear for a large sample size, and even in small sample size will provide a suitable approximate likelihood function.

To extend the results regarding CVA of multivariate random vectors to the present example of correlated vector time series, possibly with inputs, a past/future form of the likelihood function may be developed. To compute, the dimension of the past and future are truncated to a sufficiently large finite number l. Following Akaike, this dimension is determined by autoregressive (ARX) modeling and determining the optimal ARX order using the Akaike information criteria (AIC). The notation yₛ^{t}=[yₛ; . . . ;yₜ] is used to denote the output observations and similarly for the input observations uₛ^{t}.

For dynamic input-output systems with possible stochastic disturbances, one desire is characterizing the input to output properties of the system. A concern is statistical inference about the unknown parameters θ of the probability density p(Y|U,P;p₁^{l}θ) of the outputs Y=y₁^{N} conditional on the inputs U=u₁^{N} and some initial conditions p₁^{l}=[y₁^{l};u₁^{l}].

Therefore, in this example, suppose that the number of samples N is exactly N=Ml+l for some integer M. By expressing Yₗ₊₁^{M1+l}=[fₘₗ₊₁, . . . , f₂ₗ₊₁,fₗ₊₁]log p(Yₗ₊₁^{Ml+l}|pₗ₊₁,Q,θ)=

Then by successively conditioning as in, the log likelihood function of the outputs Y conditional on the initial state pₗ₊₁ at time l+1 and the input Q is:

$$log p ( {Y}_{𝓁 + 1}^{M 𝓁 + 𝓁} \vert {p}_{𝓁 + 1} , Q , θ ) = log p ( [ {f}_{M 𝓁 + 1} , … , {f}_{2 𝓁 + 1} , {f}_{𝓁 + 1} ] \vert {p}_{𝓁 + 1} , Q , θ ) = log p ( {f}_{M 𝓁 + 1} \vert [ {f}_{( M - 1 ) 𝓁 + 1} , … , {f}_{2 𝓁 + 1} , {f}_{𝓁 + 1} ] \vert {p}_{𝓁 + 1} , Q , θ ) = {\sum }_{m = 0}^{M - 1} log p ( {f}_{m 𝓁 + 𝓁 + 1} \vert {p}_{m 𝓁 + 𝓁 + 1} , Q , θ ) \qquad Equation 5$$

where Q=Q₁^{Ml+l}, so the likelihood function decomposes into the product of M multistep conditional probabilities. Next, by shifting the interval of the observations in the above by time s, the likelihood of the observations Yₗ₊₁₊ₛ^{Ml+l+s} is obtained. Consider the average of these shifted log likelihood functions which gives:

$$\begin{matrix}\frac{1}{𝓁} {\sum }_{s = 0}^{𝓁 - 1} log p ( {Y}_{𝓁 + 1 + s}^{M 𝓁 + 𝓁 + s} \vert {p}_{𝓁 + 1 + s} , Q , θ ) & Equation 6 \\ = \frac{1}{𝓁} {\sum }_{s = 0}^{𝓁 - 1} {\sum }_{m = 0}^{M - 1} log p ( {f}_{m 𝓁 + 𝓁 + 1 + s} \vert {p}_{m 𝓁 + 𝓁 + 1 + s} , Q , θ ) & Equation 7 \\ = \frac{1}{𝓁} {\sum }_{t = 𝓁 + 1}^{N} log p ( ( {f}_{t} \vert {q}_{t} ) \vert {p}_{t} , θ ) ) & Equation 8\end{matrix}$$

Now each likelihood function in this average is a likelihood of N−l points that differs only on the particular end points included in the time interval. This effect will disappear for a large sample size, and even in small sample size will provide a suitable approximate likelihood function.

The vector variables fₜ|qₜ and pₜ are typically highly autocorrelated whereas the analogous vector variables yₜ and xₜ are assumed stochastically to each be white noise with zero autocorrelation. The difference is that pₜ, fₜ, and qₜ are stacked vectors of the time shifted vectors yₜ and uₜ that themselves can be highly correlated.

Notice that the way the term fₜ|qₜ arises in (7) is that pₜ contains u₁^{t-1}, so that those of Q=u₁^{N} not contained in pₜ, namely qₜ=uₜ^{N} remain to be separately conditioned on fₜ. In further exemplary embodiments discussed below, fₜ|qₜ will be called the “future outputs with the effects of future inputs removed” or, for brevity, “the corrected future outputs”. Note that this conditioning arises directly and fundamentally from the likelihood function that is of fundamental importance in statistical inference. In particular, the likelihood function is a sufficient statistic. That is, the likelihood function contains all of the information in the sample for inference about models in the class indexed by the parameters θ. Since this relationship makes no assumption on the class of models, it holds generally in large samples for any model class with l chosen sufficiently large relative to the sample size.

In a further exemplary embodiment, it may be desired to remove future inputs from future outputs. The likelihood theory above gives a strong statistical argument for computing the corrected future outputs fₜ|qₜ prior to doing a CVA. The question is how to do the correction. Since an ARX model is computed to determine the number of past lags l to use in the finite truncation of the past, a number of approaches have been used involving the estimated ARX model.

For another perspective on the issue of removing future inputs from future outputs, consider a state space description of a process. A k-order linear Markov process has been shown to have a representation in the following general state space form:

xₜ₊₁=Φxₜ+Guₜ+wₜ Equation 9

yₜ=Hxₜ+Auₜ+Bwₜ+vₜ Equation 10

where xₜ is a k-order Markov state and wₜ and vₜ are white noise processes that are independent with covariance matrices Q and R respectively. These state equations are more general than typically used since the noise Bwₜ+vₜ in the output equation is correlated with the noise wₜ in the state equation. This is a consequence of requiring that the state of the state space equations be a k-order Markov state. Requiring the noises in Equation 9 and 10 to be uncorrelated may result in a state space model were the state is higher dimensional than the Markov order k so that it is not a minimal order realization.

Further exemplary embodiments may focus on the restricted identification task of modeling the openloop dynamic behavior from the input uₜ to the output yₜ. Assume that the input uₜ can have arbitrary autocorrelation and possibly involve feedback from the output yₜ to the input uₜ that is separate from the openloop characteristics of the system in Equation 9 and Equation 10. The discussion below summarizes a procedure for removing effects of such possible autocorrelation.

The future fₜ=(yₜ^{T}, . . . , yₜ₊ₗ^{T})^{T} of the process is related to the past pₜ through the state xₜ and the future inputs qₜ=(uₜ^{T}, . . . , uₜ₊ₗ^{T})^{T} in the form:

fₜ=Ψ^{T}xₜ+Ω^{T}qₜ+eₜ, Equation 11

where xₜ lies in some fixed subspace of pₜ, Ψ^{T}=(H; HΦ; . . . ; HΦ^{l-1}) and the i,jth block of Ω is HΦ^{j-i}G. The presence of the future inputs qₜ creates a major problem in determining the state space subspace from the observed past and future. If the term Ω^{T}qₜ could be removed from the above equation, then the state space subspace could be estimated accurately. The approach used in the CVA method is to fit an ARX model and compute an estimate \hat{Ψ} of Ψ based on the estimated ARX parameters. Note that an ARX process can be expressed in state space form with state xₜ=pₜ so that the above expressions for Ω and Ψ in terms of the state space model can be used as well for the ARX model. Then the ARX state space parameters (Φ, G, H, A) and Ψ and Ω are themselves functions of the ARX model parameters \hat{θ}_{A}.

Now since the effect of the future inputs qₜ on future outputs fₜ can be accurately predicted from the ARX model with moderate sample size, the term Ω^{T}qₜ can thus be predicted and subtracted from both sides of Equation 11. Then a CVA can be done between the corrected future fₜ−Ω^{T}qₜ and the past to determine the state xₜ. A variety of procedures to deal with autocorrelation and feedback in subspace system identification for LTI systems have been developed with comparisons between such methods.

For the development for LPV models in latter exemplary embodiments, note that the corrected future is simply the result of a hypothetical process where for each time t the hypothetical process has past pₜ and with the future inputs qₜ set to zero. The result is the corrected future outputs fₜ−Ω^{T}qₜ, i.e. the unforced response of the past state implied by the past pₜ. Now taking all such pairs (pₜ,fₜ−Ω^{T}qₜ) for some range of time t, a CVA analysis will obtain the transformation matrices of the CVA from which the state estimates can be expressed for any choice of state order k as \hat{x}ₖ=Jₖpₜ as discussed below.

The most direct approach is to use the ARX model recursively to predict the effect of the future inputs one step ahead and subtract this from the observed future outputs. The explicit computations for doing this are developed specifically for the more general LPV case.

The CVA on the past and future gives the transformation matrices J and L respectively specifying the canonical variables c and d associated with the past pₜ and the corrected future outputs fₜ|qₜ. For each choice k of state order (the rank r) the “memory” of the process (the intermediate variables zₜ) is defined in terms of the past as

mₜ=Jₖpₜ=[Iₖ0]Jpₜ, Equation 12

where the vector mₜ can be made of the first k canonical variables. The vector mₜ is intentionally called ‘memory’ rather than ‘state’. A given selection of memory mₜ may not correspond to the state of any well defined k-order Markov process since truncating states of a Markov process will not generally result in a Markov process for the remaining state variables. In particular, the memory mₜ does not usually contain all of the information in the past for prediction of the future values of mₜ, i.e. mₜ₊₁, mₜ₊₂, . . . . For the system identification problem, this is not a problem since many orders k will be considered and the one giving the best prediction will be chosen as the optimal order. This optimal order memory will correspond to the state of a Markov process within the sampling variability of the problem.

In a further exemplary embodiment, the problem of determining a state space model of a Markov process and a state space model estimation may be made. The modeling problem is: given the past of the related random processes uₜ and yₜ, develop a state space model of the form of Equations 9 and 10 to predict the future of yₜ by a k-order state xₜ. Now consider the estimation of the state space model and then its use in model order selection. Note that if over an interval of time t the state xₜ in Equations 9 and 10 was given along with data consisting of inputs uₜ and outputs yₜ, then the state space matrices Φ, G, H, and A could be estimated easily by simple linear multiple regression methods. The solution to the optimal reduced rank modeling problem is given above in terms of the canonical variables. For a given choice k of rank, the first k canonical variables are then used as memory mₜ=Jₖpₜ as in equation (12) in the construction of a k-order state space model.

In particular, consider the state Equations 9 and 10 with the state xₜ replaced with the memory mₜ determined from CVA. The multivariate regression equations are expressed in terms of covariances, denoted by Σ, among various vectors as:

$$( \begin{matrix}Φ & G \\ H & A\end{matrix} ) = Σ ( \begin{matrix}{m}_{t + 1} & {m}_{t} \\ {y}_{t} & {}_{}^{′}{u}{}_{t}^{}\end{matrix} ) {Σ}^{- 1} ( \begin{matrix}{m}_{t} & {m}_{t} \\ {u}_{t} & {}_{}^{′}{u}{}_{t}^{}\end{matrix} ) \qquad Equation 13$$

where computation is obtained by the substitution of mₜ=Jₖpₜ. The covariance matrix of the prediction error as well as matrices Q, R, and B have similar simple expressions.

In a further exemplary embodiment, an objective model structure selection may be determined, along with the state order. The CVA method permits the comparison of very general and diverse model structures such as the presence of an additive deterministic polynomial, the state order of the system dynamics, the presence of an instantaneous or delayed effect on the system output from the inputs, and the feedback and ‘causality’ or influence among a set of variables. The methods discussed below allow for the precise statistical comparison of such diverse hypotheses about the dynamical system.

To decide on the model state order or model structure, recent developments based upon an objective information measure may be used, for example, involving the use of the Akaike Information Criterion (AIC) for deciding the appropriate order of a statistical model. Considerations of the fundamental statistical principles of sufficiency and repeated sampling provide a sound justification for the use of an information criterion as an objective measure of model fit. In particular, suppose that the true probability density is p_{*} and an approximating density is pᵢ, then the measure of approximation of the model pᵢ to the truth p_{*} is given by the Kullback discrimination information:

$${I}_{Y} ( {p}_{*} , {p}_{1} ) = \int {p}_{*} ( Y ) log \frac{{p}_{*} ( Y )}{{p}_{1} ( Y )} d Y . \qquad Equation 14$$

It can be shown that for a large sample the AIC is an optimal estimator of the Kullback information and achieves optimal decisions on model order. The AIC for each order k is defined by:

AIC(k)=−2 log p(Y^{N},U^{N};\hat{θ}ₖ)+2fMₖ, Equation 15

where p is the likelihood function based on the observations (Y^{N}, U^{N}) at N time points, where \hat{θ}ₖ is the maximum likelihood parameter estimate using a k-order model with Mₖ parameters. The small sample correction factor f is equal to 1 for Akaike's original AIC, and is discussed below for the small sample case. The model order k is chosen corresponding to the minimum value of AIC(k). For the model state order k taken greater than or equal to the true system order, the CVA procedure provides an approximate maximum likelihood solution. For k less than the true order, the CVA estimates of the system are suboptimal so the likelihood function may not be maximized. However this will only accentuate the difference between the calculated AIC of the lower order models and the model of true order so that reliable determination of the optimal state order for approximation is maintained.

The number of parameters in the state space model of Equations 9 and 10 is:

Mₖ=k(2n+m)+mn+n(n+1)/2, Equation 16
where k is the number of states, n is the number of outputs, and m is the number of inputs to the system. This result may be developed by considering the size of the equivalence class of state space models having the same input/output and noise characteristics. Thus the number of functionally independent parameters in a state space model is far less than the number of elements in the various state space matrices. The AIC provides an optimal procedure for model order selection in large sample sizes.

A small sample correction to the AIC has been further been developed for model order selection. The small sample correction factor f is:

$$f = \frac{N}{N - ( \frac{{M}_{k}}{n} + \frac{n + 1}{2} )} \qquad Equation 17$$

The effective sample size N is the number of time points at which one-step predictions are made using the identified model. For a large sample N, the small sample factor f approaches 1, the value of f originally used by Akaike in defining AIC. The small sample correction has been shown to produce model order selection that is close to the optimal as prescribed by the Kullback information measure of model approximation error.

The nonlinear system identification method implemented in the CVA-LPV method and presented in this further exemplary embodiment is based on linear parameter-varying (LPV) model descriptions. The affine state space LPV (SS-LPV) model form may be utilized because of its parametric parsimony and for its state space structure in control applications. The ARX-LPV (autoregressive input/output) model form used for initial model fitting also plays a vital role. The introduction of the model forms can be followed by the fitting and comparing of various hypotheses of model structure available in the CVA-LPV procedure, as well as discussion of computational requirements.

In further exemplary embodiments, affine state space LPV models may be considered. Consider a linear system where the system matrices are time varying functions of a vector of scheduling parameters ρₜ=[ρₜ(1); ρₜ(2); . . . ; ρₜ(s)], also called parameter-varying (PV) functions, of the form:

xₜ₊₁=A(ρₜ)xₜ+B(ρₜ)uₜ+wₜ Equation 18

yₜ=C(ρₜ)xₜ+D(ρₜ)uₜ+vₜ. Equation 19

In this embodiment, only LPV systems are considered having affine dependence on the scheduling parameters of the form A(ρₜ)=ρₜ(1)A₁+ . . . +ρₜ(s)Aₛ and similarly for B(ρₜ), C(ρₜ), and D(ρₜ). Here the parameter-varying matrix A(ρₜ) is expressed as a linear combination specified by ρₜ=[ρₜ(1); ρₜ(2); . . . ; ρₜ(s)] of constant matrices A=[A₁ . . . Aₛ], called an affine form and similarly for B, C, and D. Note that (18) and (19) are a linear time-varying system with the time-variation parameterized by ρₜ.

LPV models are often restricted to the case where the scheduling functions ρₜ are not functions of the system inputs uₜ, outputs yₜ, and/or states xₜ. The more general case including these functions of uₜ, yₜ, and xₜ is often called Quasi-LPV models. In this embodiment, there is no need to distinguish between the two cases so the development will apply to both cases.

The LPV equations can be considerably simplified to a LTI system involving the Kronecker product variables ρₜ [symbol] xₜ and ρₜ [symbol] uₜ in the form:

$$( \begin{matrix}{x}_{t + 1} \\ {y}_{t}\end{matrix} ) = ( \begin{matrix}A & B \\ C & D\end{matrix} ) ( \begin{matrix}{ρ}_{t} ⊗ {x}_{t} \\ {ρ}_{t} ⊗ {u}_{t}\end{matrix} ) + ( \begin{matrix}{w}_{t} \\ {v}_{t}\end{matrix} ) \qquad Equation 20$$

where [symbol] denotes the Kronecker product M [symbol] N defined for any matrices M and N as the partitioned matrix composed of blocks i,j as (M [symbol] N)_{i,j}=m_{i,j}N with the i,j element of M denoted as m_{i,j}, and [M; N]=(M^{T} N^{T})^{T}) denotes stacking the vectors or matrices M and N. In later embodiments, further exploitation of this LTI structure will result in LTI subspace like reductions in computations and increases in modeling accuracy.

Now consider the case where the state noise also has affine dependence on the scheduling parameters ρₜ through the measurement noise vₜ, specifically where wₜ in (20) satisfies wₜ=K(ρₜ [symbol] vₜ) for some LTI matrix K. Then for the case of no parameter variation in the output Equation 19, it can be shown by simple rearrangement that the state equations are

$$\begin{matrix}{x}_{t + 1} = ( \overline{A} \overline{B} K ) ( \begin{matrix}{ρ}_{t} ⊗ {x}_{t} \\ {ρ}_{t} ⊗ {u}_{t} \\ {ρ}_{t} ⊗ {y}_{t}\end{matrix} ) & Equation 21 \\ {y}_{t} = ( C D I ) ( \begin{matrix}{x}_{t} \\ {u}_{t} \\ {v}_{t}\end{matrix} ) . \\ with {\overline{A}}_{i} = {A}_{i} - {K}_{i} C , {\overline{B}}_{i} = {B}_{i} - {K}_{i} D \\ and & Equation 22 \\ ( \begin{matrix}\overline{A} \\ \overline{B}\end{matrix} ) = ( \begin{matrix}{\overline{A}}_{1} … {\overline{A}}_{s} \\ {\overline{B}}_{1} … {\overline{B}}_{s}\end{matrix} ) & Equation 23\end{matrix}$$

In the above form, the noise in the state equation is replaced by the difference between the measured output and the predicted output vₜ=yₜ−(Cxₜ+Duₜ) that is simply a rearrangement of the measurement equation. As a result, only measured inputs, outputs and states appear in the state equations removing any need to approximate the effects of noise in the nonlinear state equations. A number of the exemplary embodiments below are of this form with D=0, where there is no direct feedthrough without delay in the measurement output equation.

In a further embodiment, the first step in the CVA-LPV procedure is to approximate the LPV process by a high order ARX-LPV model. For this embodiment, an LPV dynamic system may be approximated by a high order ARX-LPV system of the form:

$${y}_{t} = {\sum }_{i = 1}^{l} {α}_{i} ( {ρ}_{t - i} ⊗ {y}_{t - i} ) + {\sum }_{i = 0}^{l} {β}_{i} ( {ρ}_{t - i} ⊗ {u}_{t - i} ) + {v}_{t} \qquad Equation 24$$

that gives a linear prediction yₜ of the present output yₜ at time t in terms of the past outputs yₜ₋ᵢ and past and possibly present inputs uₜ₋ᵢ, where l is the order of the ARX-LPV process, and vₜ is a white noise process with covariance matrix Σᵥᵥ. The lower limit of the second sum is equal to 1 if the system has no direct coupling between input and output, i.e. β₀=0.

The ARX-LPV Equation 24 is in the shifted form where the time shifts in the scheduling functions pₜ₊ᵢ match those in the inputs uₜ₊ᵢ and outputs yₜ₊ᵢ. This is one of only a few model forms that are available to avoid the introduction of dynamic dependence in the resulting state space LPV description to be derived from the ARX-LPV model. The presence of dynamic dependence can lead to considerable inaccuracy in LPV models.

Notice that in Equation 24, the parameter-varying schedule functions pₜ₋ᵢ can be associated, or multiplied, either with the constant matrix coefficients αᵢ and βᵢ or the data yₜ and uₜ. In the first case, the result is the parameter-varying coefficients αᵢ(ρₜ₋ᵢ [symbol] I_{y}) and βᵢ(ρₜ₋ᵢ [symbol] Iᵤ) respectively to be multiplied by yₜ₋ᵢ and uₜ₋ᵢ, where the dimensions of the identity matrix I_{y} and Iᵤ are respectively the dimensions of y and u. In the second case, since the time shift t−i is the same in all the variables yₜ₋ᵢ, uₜ₋ᵢ and ρₜ₋ᵢ, the augmented data {ρₜ [symbol] yₜ, ρₜ [symbol] uₜ} can be computed once for each time t and used in all subsequent computations.

The past of the ARX-LPV process is defined as pₜ=[ρₜ₋₁ [symbol] yₜ₋ᵢ; ρₜ₋ᵢ [symbol] uₜ₋₁; . . . ; ρₜ₋ₗ [symbol] yₜ₋ₗ; ρₜ₋ₗ [symbol] uₜ₋ₗ] with the terms of the ARX-LPV model that are multiplied by the LTI coefficients αᵢ and βⱼ for j>0. The past pₜ is a state for the ARX-LPV process since it contains all of the information in the past for linear prediction of the future evolution of the process. The past pₜ is in general not miminal order and often much higher than minimal order. Notice that the evolution is dependent on the schedule ρₜ, so if the schedules ρₜ≠ ρ̅ₜ differ then the corresponding states pₜ≠ p̅ₜ differ. Note that the schedule ρₜ can be chosen arbitrarily or various changes in the schedule can be considered with corresponding changes in the past.

As further described herein, the association of the scheduling functions ρₜ with the data will allow the direct adaptation of the CVA subspace method for linear time invariant (LTI) systems to LPV systems including all of the computational and numerical advantages of the LTI method. In particular, the ARX-LPV equations become LTI in the augmented data, and calculation of the coefficient estimates for the ARX-LPV model is nearly the same as for an ARX-LTI model using the augmented data.

In this embodiment as well as those following, the CVA subspace identification method described previously can be made applicable LTI systems is extended to LPV systems. This development has considerable significance since previous methods for the identification of LPV systems require nonlinear iterative optimization that can have accuracy and/or convergence problems, or require subspace computational methods that grow exponentially with the number of inputs, outputs, states, and ARX-LPV order l. It will be shown that the CVA subspace identification method for LPV systems grows only as the cube of the number of such variables rather than exponentially.

The adaptation of the method to LPV systems involves the following steps:
Fit ARX-LPV models of sufficiently high order and compute the AIC for each order to determine the optimal order.
Remove the effects of future inputs on future outputs using the optimal ARX-LPV model order to determine the corrected future.
Do a CVA between the past and corrected future to determine optimal candidate state estimates, and sort these estimates by their predictive ability, i.e. correlation with future.
Compute the AIC for each state order to select the optimal state order.
Compute SS-LPV models for the optimal state order and other state orders of possible interest.

In a further embodiment, future inputs may be removed from future outputs. Here, the following definitions will be useful for a given time t: the past augmented inputs and outputs pₜ₋₁=[ρₜ₋₁ [symbol] yₜ₋₁; ρₜ₋₁ [symbol] uₜ₋₁; . . . ; ρₜ₋ₗ [symbol] yₜ₋ₗ; ρₜ₋ₗ [symbol] uₜ₋ₗ], or just past for brevity, the future outputs fₜ(y)=[yₜ₊ₗ; yₜ₊ₗ₋₁; . . . ; y_{y}], and the future inputs qₜ=[uₜ₊ₗ; uₜ₊ₗ₋₁; . . . ; uₜ]. The terms future inputs or future outputs include the present time t, and the length l of the past is the order e of the ARX-LPV model in Equation 24 for which the AIC is nominally a minimum. By removing the effects of future inputs on future outputs, it will be shown below that the resulting future outputs, called the corrected future and denoted fₜ(y)|qₜ, are then the result of the free response of the present state that is strictly a function of the past pₜ at time t of the system with the future inputs qₜ effectively set to zero. The state of the system can then be computed by doing a CVA between the past and the corrected future as it is done below.

The corrected future is computed iteratively using the optimal ARX-LPV model developed in the previous section. Several simplifications will greatly simplify the calculation. In the discussion below, it will be useful to view the ARX-LPV system from Equation 24 with the ARX coefficients α and β and parameter varying functions ρₜ fixed and as producing output sequences y|₁^{N} from input sequences u|₁^{N}, where the notation is a shorthand for the whole sequence y|₁^{N}≅[y₁; y₂; . . . ; y_{N}] from t=1 to t=N, or some other contiguous subset of positive integers. By convention, the values of the sequences for non-positive integers are assumed to be the zero scaler or appropriately dimensioned zero vector. The sum of two sequences may be defined to be the sum of the elements with corresponding time indices.

First it will be shown that for the ARX-LPV of Equation 24, if ūₜ and ũₜ are two input sequences and the corresponding output sequences are y̅ₜ and \tilde{y}ₜ, then the output yₜ of the sum sequence uₜ=ūₜ+ũₜ of two input sequences is the sum of the corresponding output sequences so yₜ= y̅ₜ+\tilde{y}ₜ. This is stated in the following theorem (Theorem 1 below) with the y|₁^{N}=ARX_{ρ|}_{₁}_{^{N}}(u|₁^{N}) denoting y|₁^{N} as the outputs of (24) with inputs u|₁^{N} and with fixed ARX coefficients α and β, and fixed parameter varying functions ρₜ. Note that what is effectively implemented is to determine the unforced response of the ARX process with the ρₜ fixed to the past pₜ. This is the device for calculating the corrected future much as for the LTI case previously. Neither the inputs uₜ, the outputs yₜ nor the PV functions ρₜ are actually changed.

Theorem 1 (Additivity of Sequences): Let the ARX-LPV input-output relationship of Equation 24 with the noise vₜ=0 for all t have finitely valued coefficients αᵢ and βᵢ, and let the parameter-varying functions ρ|₁^{N} be finitely valued and fixed. Let ū|₁^{N} ff and ũ|₁^{N} be any finitely valued input sequences and denote the sum as u|₁^{N}=ū|₁^{N}+ũ|₁^{N}. Then the effects of these input sequences on the outputs are additive in the sense that:

ARX_{ρ|}_{₁}_{^{N}}(ū|₁^{N}+ũ|₁^{N})=ARX_{ρ|}_{₁}_{^{N}}(ū|₁^{N})+ARX_{ρ|}_{₁}_{^{N}}(ũ|₁^{N}). Equation 25

Continuing with this rationale, the input-output relationship in Equation 24 with the noise vₜ=0 for all t can have finitely valued coefficients αᵢ and βᵢ and the parameter varying functions ρ₁^{N} be finitely valued. Then let ūᵢ^{N} and ũ₁^{N} be any finitely valued input sequences and denote the sum as û₁^{N}=ū₁^{N}+ũ₁^{N}. Then the effects of these input sequences on the outputs are additive in the sense that:

ARX(ū₁^{N}+ũ₁^{N})=ARX(ū₁^{N})+ARX(ũ₁^{N}) Equation 26

Thus, it is sufficient to show that using Equation 24 to predict the present output y|₁^{N} from the past inputs and outputs is additive in the inputs as in Equation 26. Then this additivity can be used recursively to show the additivity for any future outputs.

This follows simply since the Kronecker product satisfies α(ρ [symbol] ( y̅+\tilde{y}))=α((ρ [symbol] y̅)+(ρ [symbol] \tilde{y})) so:

$$\begin{matrix}{y}_{t} = {\sum }_{i = 1}^{k} {α}_{i} {ρ}_{t - i} ⊗ {y}_{t - i} + {\sum }_{i = 0}^{k} {β}_{i} {ρ}_{t - i} ⊗ {u}_{t - i} & Equation 27 \\ = {\sum }_{i = 1}^{k} {α}_{i} {ρ}_{t - i} ⊗ ( {\overline{y}}_{t - i} + {\tilde{y}}_{t - i} ) + {\sum }_{i = 0}^{k} {β}_{i} {ρ}_{t - i} ⊗ ( {\overline{u}}_{t - i} + {\tilde{u}}_{t - i} ) & Equation 28 \\ = ( {\sum }_{i = 1}^{k} {α}_{i} {ρ}_{t - i} ⊗ {\overline{y}}_{t - i} + {\sum }_{i = 1}^{k} {α}_{i} {ρ}_{t - i} ⊗ {\tilde{y}}_{t - i} ) + & Equation 29 \\ ( {\sum }_{i = 0}^{k} {β}_{i} {ρ}_{t - i} ⊗ {\overline{u}}_{t - i} + {\sum }_{i = 0}^{k} {β}_{i} {ρ}_{t - i} ⊗ {\tilde{u}}_{t - i} ) & Equation 30 \\ = ( {\sum }_{i = 1}^{k} {α}_{i} {ρ}_{t - i} ⊗ {\overline{y}}_{t - i} + {\sum }_{i = 0}^{k} {β}_{i} {ρ}_{t - i} ⊗ {\overline{u}}_{t - i} ) + & Equation 31 \\ ( {\sum }_{i = 1}^{k} {α}_{i} {ρ}_{t - i} ⊗ {\tilde{y}}_{t - i} + {\sum }_{i = 0}^{k} {β}_{i} {ρ}_{t - i} ⊗ {\tilde{u}}_{t - i} ) & Equation 32 \\ = {\overline{y}}_{t} + {\tilde{y}}_{t} & \end{matrix}$$

The sequences for yₜ and uₜ are defined to be zero for non-positive integers so the additivity holds for t=1. To prove by induction, we only need to show that if it holds for a given t−1 then it also holds for t. In the above equation, all of the use of additivity in the y's occurs involving index t−1 and less which justifies the final equality of yₜ= y̅ₜ+\tilde{y}ₜ. QED

The above additive effects of input sequences on output sequences results in a simple additive correction to obtain the corrected future outputs fₜ(y)|(qₜ=0) from the future inputs qₜ=u|ₜ^{t+l} as stated below in Theorem 2.

Theorem 2 (Corrected Future): Let the ARX-LPV process of order l be given by Equation 24 with the noise vₜ=0 for all t have finitely valued coefficients αᵢ and βᵢ, and let the parameter-varying functions ρ|₁^{N} be finitely valued and fixed. Let \tilde{y}|ₜ^{t+l}=ARX(uₜ^{t+l}) denote the future ARX outputs as a result of future inputs qₜ=u|ₜ^{t+l} with inputs prior to time t being zero. This correction is computed recursively for j=0, 1, . . . , l as:

\tilde{y}ₜ₊ⱼ=Σᵢ₌₁^{j}αᵢ(ρₜ₊ⱼ₋ᵢ [symbol] \tilde{y}ₜ₊ⱼ₋ᵢ)+Σᵢ₌₀^{j}βᵢ(ρₜ₊ⱼ₋ᵢ [symbol] uₜ₊ⱼ₋ᵢ).

Then the corrected future outputs y̅|ₜ^{t+l}=fₜ(y)|(qₜ=0) are given by:

y̅|ₜ^{t+l}=y|ₜ^{t+l}−\tilde{y}|ₜ^{t+l}. Equation 33

As proof of this theorem, and for convenience, the zero vector sequence for time t from M to N is denoted as 0|_{M}^{N}. Now for each time t, consider the input sequence ũ|₁^{t+l} as the future inputs qₜ preceeded by t−1 zeros with ũ={u|₁^{t-1},0|ₜ^{t+l}}. Then by subtracting ũₜ from the actual input sequence u|₁^{t+l} the resulting input sequence is:

ū|₁^{t+l}={u|₁^{t-1},0|ₜ^{t+l}} Equation 34

where the future fₜ of this input sequence is exactly the zero sequence. Now by construction:

u|₁^{t+l}=ũ|₁^{t+l}+ū|₁^{t+l} Equation 35

so the desired corrected future response is obtained from the output sequence y̅|₁^{t+1} resulting from the difference of the input sequences:

ū|₁^{t+l}=u|₁^{t+l}−ũ|₁^{t+l}. Equation 36

The corrected future output sequence is thus:

$$\begin{matrix}\overline{y} {\vert}_{1}^{t + l} = ARX ( \overline{u} {\vert}_{1}^{t + l} ) & Equation 37 \\ = ARX ( u {\vert}_{1}^{t + l} ) - ARX ( \tilde{u} {\vert}_{1}^{t + l} ) & \\ = y {\vert}_{1}^{t + l} - ARX ( \tilde{u} {\vert}_{1}^{t + l} ) & Equation 38 \\ = y {\vert}_{1}^{t + l} - ARX ( \{ 0 {\vert}_{1}^{t - 1} , u {\vert}_{t}^{t + l} \} ) & \\ = y {\vert}_{1}^{t + l} - \{ 0 {\vert}_{1}^{t - 1} , \tilde{y} {\vert}_{t}^{t + l} \} & Equation 39\end{matrix}$$

with the corrected future given as the future of the last expression:

y̅|ₜ^{t+l}=y|ₜ^{t+l}−\tilde{y}|ₜ^{t+l}. Equation 40

To compute the corrected future using (40), only the output \tilde{y}=ARX({0|₁^{t-1},u|ₜ^{t+l}}) of the ARX system due to the future inputs needs to be computed. Since the input is zero before time t, that is easily computed recursively for j=0, 1, . . . , l as:

\tilde{y}ₜ₊ⱼ=Σᵢ₌₁^{j}αᵢ(ρₜ₊ⱼ₋ᵢ [symbol] \tilde{y}ₜ₊ⱼ₋ᵢ)+Σᵢ₌₀^{j}βᵢ(ρₜ₊ⱼ₋ᵢ [symbol] uₜ₊ⱼ₋ᵢ).

### QED

As in the discussion of the CVA of LTI systems, the corrected future outputs is precisely the unforced future response of the ARX model with fixed ρₜ to the past pₜ with no future input qₜ.

Having removed the effects of future inputs on future outputs to obtain the corrected future, the corrected future is then the free response of the augmented past. The following Theorem can be used to display the structure of the LPV case.

Theorem 3 (LTI Structure of Past Corrected Future): Consider the ARX-LPV process Equation 24 of order l lags with no noise (vₜ=0). Then for all t such that l+1<t<N−l, the corrected future outputs fₜ( y̅)=[ y̅ₜ₊ₗ; . . . ; y̅ₜ], as defined in theorem 2, are LTI functions of the corrected augmented future fₜ(ρ [symbol] y̅)=[ρₜ₊ₗ [symbol] y̅ₜ₊ₗ; . . . ; ρₜ [symbol] y̅ₜ] and the augmented past pₜ=[ρₜ₋₁ [symbol] yₜ₋₁; . . . ; ρₜ₋ₗ [symbol] yₜ₋ₗ; ρₜ₋₁ [symbol] uₜ₋₁; . . . ; ρₜ₋ₗ [symbol] uₜ₋ₗ], and are expressed recursively in matrix form as:

$${( {\overline{y}}_{t + l} ; {\overline{y}}_{t + l - 1} ; … ; {\overline{y}}_{t + 1} ; {\overline{y}}_{t} )}^{T} = \underbrace{( \begin{matrix}0 & {α}_{1} & … & {α}_{l - 1} & {α}_{l} \\ & ⋱ & ⋱ & ⋮ & ⋮ \\ ⋮ & & ⋱ & {α}_{1} & {α}_{2} \\ & & & ⋱ & {α}_{1} \\ 0 & & … & & 0\end{matrix} )}_{= : {α}_{f}} ( \begin{matrix}{ρ}_{t + l} ⊗ {\overline{y}}_{t + l} \\ {ρ}_{t + l - 1} ⊗ {\overline{y}}_{t + l - 1} \\ ⋮ \\ {ρ}_{t + 1} ⊗ {\overline{y}}_{t + 1} \\ {ρ}_{t} ⊗ {\overline{y}}_{t}\end{matrix} ) + \underbrace{( \begin{matrix}0 & … & & 0 \\ {α}_{l} & ⋱ & & \\ ⋮ & ⋱ & ⋱ & ⋮ \\ {α}_{2} & … & {α}_{l} & 0 \\ {α}_{1} & … & {α}_{l - 1} & {α}_{l}\end{matrix} )}_{= : {α}_{p}} ( \begin{matrix}{ρ}_{t - 1} ⊗ {\overline{y}}_{t - 1} \\ {ρ}_{t - 2} ⊗ {\overline{y}}_{t - 2} \\ ⋮ \\ {ρ}_{t - l + 1} ⊗ {\overline{y}}_{t - l + 1} \\ {ρ}_{t - l} ⊗ {\overline{y}}_{t - l}\end{matrix} ) + \underbrace{( \begin{matrix}0 & … & & 0 \\ {β}_{l} & ⋱ & & \\ ⋮ & ⋱ & ⋱ & ⋮ \\ {β}_{2} & … & {β}_{l} & 0 \\ {β}_{1} & … & {β}_{l - 1} & {β}_{l}\end{matrix} )}_{= : {β}_{p}} ( \begin{matrix}{ρ}_{t - 1} ⊗ {u}_{t - 1} \\ {ρ}_{t - 2} ⊗ {u}_{t - 2} \\ ⋮ \\ {ρ}_{t - l + 1} ⊗ {u}_{t - l + 1} \\ {ρ}_{t - l} ⊗ {u}_{t - l}\end{matrix} ) \qquad Equation 41$$

The matrix equation describes, for each t+j for 0≦j≦l, a recursion in computing the corrected future output y̅ₜ₊ⱼ. This result is then used along with the parameter-varying functions ρₜ₊ⱼ that are known in real time to compute the elements ρₜ₊ⱼ₊₁ [symbol] y̅ₜ₊ⱼ₊₁ of the corrected augmented future f̅ₜ. Then the next recursion for t+j+1 can be computed. A more compact form of the above equation is:

fₜ( y̅)=α_{f}fₜ(ρ [symbol] y̅)+[αₚβₚ]pₜ, Equation 42

As proof of this, the desired result is obtained in the following steps.

First, in Equation 24, replace t by t+j, and then consider t as fixed as the present dividing the past and future with j considered as a variable with j=0, 1, . . . , l for recursive computation of Equation 24.

Second, for each j, the computation of terms in Equation 24 are partitioned into present-future terms (with sums from i=0 or 1 to j) and into past terms (with sums from i=j+1 to l) as

yₜ₊ⱼ=Σᵢ₌₁^{j}αᵢ(ρₜ₊ⱼ₋ᵢ [symbol] yₜ₊ⱼ₋ᵢ)+Σᵢ₌₀^{j}βᵢ(ρₜ₊ⱼ₋ᵢ [symbol] uₜ₊ⱼ₋ᵢ)+Σᵢ₌ⱼ₊₁^{l}αᵢ(ρₜ₊ⱼ₋ᵢ [symbol] yₜ₊ⱼ₋ᵢ)+Σᵢ₌ⱼ₊₁^{l}βᵢ(ρₜ₊ⱼ₋ᵢ [symbol] uₜ₊ⱼ₋ᵢ)

Third, by subtracting Equation 26 from both sides of the above equation and using Equation 25, the result obtains:

$$\begin{matrix}{\overline{y}}_{t + j} = {\sum }_{i = 1}^{j} {α}_{i} ( {ρ}_{t + j - i} ⊗ {\overline{y}}_{t + j - i} ) + & Equation 43 \\ {\sum }_{i = j + 1}^{l} {α}_{i} ( {ρ}_{t + j - i} ⊗ {y}_{t + j - i} ) + {\sum }_{i = j + 1}^{l} {β}_{i} ( {ρ}_{t + j - i} ⊗ {u}_{t + j - i} ) & Equation 44\end{matrix}$$

where the terms are partitioned into sums of terms involving time indices prior to t, (i=1, . . . . , j), and time indices later than or equal t; (i=j+1, . . . , l). This may also be shown in matrix form.

As in the LTI case discussed above, the future inputs introduce errors into the system identification and need to be removed from both sides of the equation by subtraction. This leaves the unforced response of the state due to past inputs and outputs. The compact form (3) can be rewritten as:

(I−α_{f})fₜ(ρ [symbol] y̅)=[αₚβₚ]pₜ Equation 45

This follows since the first component of the scheduling vector ρₜ is the constant 1 so each of the future corrected terms y̅ₜ₊ᵢ for i=1, . . . , l composing the vector fₜ( y̅) of future corrected outputs are included as a subvector in the corrected augmented future vector fₜ(ρ [symbol] y̅) Let Ī=[I_{dimy,dimy×(dimρ-1)}] so that Ī(ρₜ₊ₗ₋ᵢ [symbol] y̅ₜ₊ₗ₋ᵢ= y̅ₜ₊ₗ₋ᵢ. Let Diag(Ī,n) be the n×n block diagonal matrix with diagonal blocks composed of Ī. Then fₜ( y̅)=Diag(Ī,n)fₜ(ρ [symbol] y̅) so Equation implies Equation 45.

From Equation 3, since the coefficient matrices (Ī−α_{f}) and [αₚ βₚ] are LTI, the relationship between the past pₜ and corrected augmented future f̅ₜ is time invariant for all t. Thus a CVA can be done between these vectors as if they are LTI processes to obtain the state of the process. Also note that from Equation 3 the information from the past is provided only through an LTI function of the past plus an LTI function of the augmented corrected future. And this information is explicitly dependent on the schedule ρₜ. This structure justifies the use of a LTI CVA to obtain the state of the ARX-LPV process for use in state order selection and estimation of constant matrix [A B; C D] in the LPV state Equation 20 discussed below.

In a further exemplary embodiment, a maximum likelihood reduced rank state estimate may be utilized. The use of the multistep log likelihood function for various cases including that of inputs and feedback for LTI systems may be utilized. For example, it can be used to prove the asymptotic convergence of the CVA algorithm to obtain asymptotically maximum likelihood estimates for the case of LTI systems with no inputs or white noise inputs. The theorem below extends it to the case of LPV systems.

Theorem 4 (ML State Estimation of Reduced Rank): For a LPV-ARX process of order l lags, the asymptotic gaussian log likelihood function of the observed outputs y|ₗ^{N} conditional on the initial past pₗ and the observed inputs u|₁^{N} and as a function of the reduced rank regression parameters, can be expressed in the multistep ahead form:

$$log p ( ( y {\vert}_{1}^{N} ) \vert {p}_{l} , ( u {\vert}_{1}^{N} ) , ( ρ {\vert}_{1}^{N} ) , θ ) = \frac{1}{ζ} {\sum }_{t = l + 1}^{N - l} log p ( ( {f}_{t} ( \overline{y} ) \vert {p}_{t} , θ ) \qquad Equation 46$$

where fₜ( y̅) is the vector of corrected future outputs of dimension ζ, and pₜ is the vector of augmented past outputs and possibly inputs as in theorem 3. The maximum likelihood solution for a state of rank r is obtained by a canonical variate analysis between the augmented past pₜ and the corrected future outputs fₜ( y̅), and by choosing the state specified by the first r canonical variables xₜ^{(r)}=Jᵣpₜ given by the first r rows of J.

The parameterization in the likelihood is the CVA regression parameterization between past and future that does not incorporate the time shift invariance properties of a LPV state space model. This is refined further in the exemplary embodiment below and used to evaluate the model fit accuracy and select the optimal state order. The nested ML model projection for the LTI case from ARX into CVA, and finally into SS form may be realized, and the LTI case easily generalizes to the present LPV case.

In a further embodiment, a state space order selection and model estimation may be made. The canonical variables determined by the CVA of past and corrected future provide the candidate state variables. For a rank r candidate state vector xₜ^{(r)}=Jᵣpₜ, the LPV state equations can be written in an order recursive computation in the state since the Kronecker product elements ρₜ [symbol] xₜ involving the state variables can be reordered as xₜ [symbol] ρₜ=[x_{1,t}ρₜ;x_{2,t}ρₜ, . . . ,x_{k,t}ρₜ] with corresponding reorder of the columns of A and C to Ã and \tilde{B}, respectively in Equation 20. Similarly, the covariance matrix of the residual prediction error in Equation 20 can be easily computed.

The better choices for states are determined by computation of the AIC for each choice of state order. In the case of noise in the process, the various matrices are of full rank so the appropriate state order is not obvious. For the case of gaussian noise in an LPV process, the AIC provides an optimal selection of state order.

In the next embodiment, an LPV extension to affine nonlinear system can be performed. The class of affine nonlinear system are systems expressed as linear combinations of basis functions, usually meaning monomials. In this section, the approximation of a general nonlinear system with continuous input-output map or state equations involving continuous functions is discussed. First a nonlinear set of state equations involving analytic functions are approximated by polynomial functions and expressed in bilinear equations of LPV form. This permits use of the LPV system identification methods. Then the universal properties of such affine nonlinear approximation methods are discussed. This leads to a heirarchical structure involving polynomial degree, and within a given degree to a set of models ordered by the state order.

For affine state space models, general nonlinear, time-varying, and parameter-varying dynamic system can be described by a system of nonlinear state equations of the form:

xₜ₊₁=f(xₜ,uₜ,ρₜ,vₜ) Equation 47

yₜ=h(xₜ,uₜ,ρₜ,vₜ) Equation 48

where xₜ is the state vector, uₜ is the input vector, yₜ is the output vector, and vₜ is a white noise measurement vector. To deal with ‘parameter-varying’ systems, the ‘scheduling’ variables ρₜ are time-varying parameters describing the present operating point of the system.

For simplicity and intuitive appeal, the case of functions admitting Taylor expansions where ρₜ and vₜ are absent leads to (extending case of uₜ a scalar to the case of uₜ a vector):

$$\begin{matrix}{x}_{t + 1} = {\sum }_{i = 0}^{J} {\sum }_{j = 0}^{J} {F}_{ij} ( {x}_{i}^{( i )} ⊗ {u}_{t}^{( j )} ) & Equation 49 \\ {y}_{t} = {\sum }_{i = 0}^{J} {\sum }_{j = 0}^{J} {H}_{ij} ( {x}_{t}^{( i )} ⊗ {u}_{t}^{( j )} ) & Equation 50\end{matrix}$$

where the notation xₜ⁽ⁱ⁾ is defined recursively as xₜ⁽ⁱ⁾=xₜ [symbol] xₜ⁽ⁱ⁻¹⁾ and similarly for uₜ^{(j)} where xₜ⁽¹⁾=xₜ and uₜ⁽⁰⁾ is defined as the vector of 1s of dimension that of uₜ.

The equations can be simply converted via Carleman bilinearization to bilinear vector discrete-time equations in the state variable [symbol] =[xₜ⁽¹⁾;xₜ⁽²⁾; . . . xₜ^{(J)}], and the input power and products variables [symbol] =[uₜ⁽⁰⁾; uₜ⁽¹⁾; . . . uₜ^{(J-1)}] resulting in the state-affine form:

$$\begin{matrix}{x}_{t + 1}^{⊗} = {\sum }_{i = 0}^{J - 1} {A}_{i} ( {u}_{t}^{( i )} ⊗ {x}_{t}^{⊗} ) + {\sum }_{i = 0}^{J - 1} {B}_{i} ( {u}_{t}^{( i )} ⊗ {u}_{t} ) & Equation 51 \\ {y}_{t} = {\sum }_{i = 0}^{J - 1} {C}_{i} ( {u}_{t}^{( i )} ⊗ {x}_{t}^{⊗} ) + {\sum }_{i = 0}^{J - 1} {D}_{i} ( {u}_{t}^{( i )} ⊗ {u}_{t} ) & Equation 52\end{matrix}$$

These bilinear equations can be expressed in the state-affine LPV form with ρₜ= [symbol] as:

[symbol]

=A(ρₜ [symbol] [symbol] )+B(ρₜ [symbol] uₜ) Equation 53

yₜ=C(ρₜ [symbol] [symbol] )+D(ρₜ [symbol] uₜ) Equation 54

Then, in a further embodiment, the more general form of the nonlinear state equations may be considered. In this case the scheduling parameters may be denoted by ρ̅ₜ as distinct from the input product terms [symbol] . These scheduling parameters pₜ may be nonlinear functions of the operating point or other known or accurately measured variables qualifying as scheduling functions. Then the composite scheduling functions ρₜ= p̅ₜ [symbol] [symbol] can be defined that include both the polynomials [symbol] in the inputs and the scheduling functions ρ̅ₜ. Then the bilinear equations again include this case.

The simplicity of the affine bilinear equations belies the considerable number of terms and complexity because much of the nonlinearity is adsorbed into the PVs. But this is far simpler than an expansion in an exponentially growing number of impulse response terms in Volterra series or the exponentially growing number of rows in the QR decomposition of other LPV subspace methods. The dimension of the state [symbol] of the LPV equation is r+r²+ . . . +r^{J}=−1+(r^{J+1}−1)/(r−1) where r is the dimension of the nonlinear state xₜ of (47), and similarly the dimension of [symbol] is 1+r+r²+ . . . +r^{J-1}=(r^{J}−1)/(r−1) where r the dimension of uₜ. So the dimensions of [symbol] and [symbol] grow exponentially in the degree J of the expansion.

Thus it is desirable to choose the degree only high enough to achieve the desired accuracy. If there is noise or disturbances in the process or data, then it may be possible to determine the point at which increasing the degree of the approximation does not increase the accuracy. This situation may be detected by computing the ARX-LPV model fitting order recursive in J, where any lack of statistical significance with increasing degree can be determined with low order linear computations. Similarly, the significance of the PV functions can be determined with addition/deletion of various of the PV functions. After exhausting the structure selection of these ‘composite scheduling functions’ in the ARX-LPV fitting, the CVA subspace model identification does automatic order reduction. The need for the various states in LPV state vector [symbol] is evaluated in the canonical variate analysis, and those of no statistical significance are discarded to obtain a minimal state order realization.

Then, in still a further exemplary embodiment, affine nonlinear systems may be identified. Below some of the issues and results relevant to system identification and the nonlinear CVA method for system identification are described.

Affine nonlinear systems have the property of a universal approximator that is of considerable importance. Given any LTI system, it is possible to approximate any such system by choosing a sufficiently high state order system as an approximator. A similar property is available for approximating continuous nonlinear systems by state affine (polynomial) systems.

The universal approximation property of state affine systems gives the opportunity to devise a systematic approximation procedure. In the context of CVA nonlinear subspace identification, the universal approximation property applies to both the affine approximation of an continuous input-output difference equation description as well as a state affine approximation. The CVA procedure starts with obtaining an (N)ARX-LPV input-output description by solving a simple linear regression computation and then using the CVA-LPV method to obtain a LPV-state space model description. In particular, the state affine form is exactly a bilinear form with higher order polynomials in the inputs as parameter-varying functions.

Then, the nonlinear model structures may be fitted and compared. In fitting the ARX-LPV models, the maximum likelihood estimates of the parameters αᵢ, βᵢ, l and Σᵥᵥ are given by treating the augmented data as if it were inputs uₜ and outputs yₜ from an (N)ARX model. In computing the (N)ARX-LPV model, the computation can be structured in an order-recursive fashion so that models are successively computed for ARX orders 1, 2, . . . , maxord, using efficient methods that require little additional computation over that of computing only the highest order maxord. This can include the computation of the Akaike information criteria (AIC) for each ARX-LPV model order fitted, that can subsequently be used to select the optimal ARX-LPV order by choosing the minimum AIC. If the optimal order is close to the maximum order considered, then the maximum order, maxord, can be increased such as by doubling and the AIC for the resulting higher orders evaluated and the new minimum AIC determined.

This same order-recursive method allows for comparing any nested models consisting of subsets of PV functions ρₜ=[ρₜ(1); . . . ; ρₜ(s)]. This allows for highly efficient fitting and comparison of nested hypotheses such as subset selection using the leaps and bounds method and nested ordering. For example in the nonlinear extension described above, the polynomial degree J of the Taylor expansion specifies the hypothesis H_{J} corresponding to ρₜ=[1;uᵢ⁽¹⁾; . . . ;uᵢ^{(J-1)}] to produce the nested sequence H₀⊂H₁⊂ . . . H_{J}.

For each model structure H_{ρ} depending on structural parameters of ρ considered in the ARX-LPV model fitting, automatic computation of the optimal ARX-LPV order l is performed and the AIC is evaluated for multiple comparison of the hypotheses.

In implementing the CVA procedure above for fitting SS-LPV models, a sequence of nested state estimates is obtained and the AIC computed for comparison of various state orders. The model state order reduction by CVA can be considerable, especially for the bilinear models since the Kronecker product state can have considerable redundancy that includes differently labeled monimials like x₁x₃⁴x₂³ and x₃⁴x₁x₂³.

The computational requirements for the subspace identification of SS-LPV models is dominated by the dimension dim(pₜ) of the augmented past pₜ. For the LPV case, dim(pₜ) is the factor dim(ρₜ) larger than for the LTI case for the same length l of the past. The major computation is the CVA that is proportional to [dim(pₜ)]³, so the computation increases by the factor [dim(ρₜ)]³. For bilinear systems, [dim(ρₜ)] grows exponentially as [dim(uₜ)]^{(J-1)}.

In another exemplary embodiment, subspace identification of an aircraft linear parameter-varying flutter model may be described. The following description and figures are exemplary in nature and other manners of utilizing the technology and embodiments described herein are envisioned.

The process of system identification of an linear parameter-varying (LPV) system using subspace techniques is demonstrated by application to the widely used pitch-plunge model of an aircraft flutter simulation. The identification is done using a recently published subspace identification (SID) algorithm [17] for LPV systems. The objective is to demonstrate the ability of this method to not only identify a highly accurate model in state space form, but to also determine the state order of the system. As the identification data are gained from simulation, a comparison is given between the noiseless and the noisy case, and the effects of noise especially on the model order estimation are discussed.

In another exemplary embodiment, linear-parameter-varying (LPV) systems have been utilized in research as well as in control application. One attraction of LPV systems is the possibility of determining a global model over an extended region of the operating parameter space based on data in a limited region of the operating parameter space. For an aircraft simulation, for example, this permits the prediction and extrapolation of the flight characteristics into regions of the operating parameter space where no actual data was previously available.

For a fixed operating point, LPV systems behave like a linear and time-invariant (LTI) system. If the operating point changes, the parameters of the linear dynamics change by functions of the operating point. An example that is easy to visualize is a spring, mass, and damper system with linear dynamics. If this is part of a vehicle is travelling down a road, then the response in the system depends to a great degree on the speed of the vehicle. In effect, the forces from the road are speed dependent and scaled by functions of the speed. More generally, the states and inputs of the LTI system are multiplied by functions of the operating point and feed back into the LTI system. The dynamics remain LTI independent of the operating point (i.e. speed in the example). This is the fundamental structure of LPV systems. In fact, the feedback scaling is governed by the laws of physics expressed as a function of the operating point.

As described herein and with the below exemplary embodiments, subspace methods, where the order and parameters are unknown, are utilized and a state-space described description can be formed as a result of the identification process.

Subspace identification (SID), or subspace-based state-space system identification (4SID) at length, denotes a class of black-box identification methods that estimate non-iteratively the order as well as the parameters of a dynamic system. Classical algorithms in this class of identification methods are canonical variate analysis (CVA), numerical algorithms for subspace-based state-space system identification (N4SID), multivariable output error state space identification (MOESP) and predictor-based subspace-identification PBSID), which in their basic versions all result in a discrete-time state-space description of a LTI system.

Additionally, there exist several extensions of the above mentioned SID methods for special classes of nonlinear systems, bilinear systems, or LPV systems. The algorithm in is based on the MOESP method, whereas the algorithms in are based on PBSID. The main drawback of these LPV algorithms using the classical background of LTI subspace identification is the exponentially growing size of the matrices depended on the number of past lags, which should be at least as high as the system order, as well as the lack of an integrated and reliable order selection criterion. These drawbacks are also inherited by a recursive variant of the LPV-PBSID proposed in, where size of the data matrices is at least independent of the number of data samples.

To reduce the size of the data matrices within the algorithms, kernel versions of the LPV-MOESP and LPV-PBSID, respectively can be introduced. Still, the memory requirements of those algorithms remain high for LPV systems. Depending on the number of samples and scheduling parameters, already a past horizon of 10 or below can be challenging or not feasible on today's high end PCs.

New subspace methods addressing the memory consumption issue are proposed based on CVA. These new LPV subspace methods have computational requirements similar to subspace identification methods for linear time-invariant models, except that the number of ‘lagged variables’ is multiplied by one plus the number of parameter-varying functions. These methods produce statistically optimal models having high accuracy when there is sufficient signal-to-noise ratio and data length. For demonstrating the LPV subspace identification process, the new methods from are applied to data of a pitch-plunge simulation in this contribution.

This exemplary embodiment can provide a short review on the used CVA-based LPV subspace method. Then pitch-plunge model may be introduced and identification results for a noiseless case as well as for a data set including measurement noise can follow.

In this exemplary embodiment, with the idea of LPV-CVA, similar to other LPV subspace approaches, it may be desired to rewrite the LPV identification problem in a form that the LTI methods can be applied. CVA for LTI systems is a statistically based subspace identification approach. Related LTI methods and their asymptotic equivalence to CVA may be utilized for the case of no noise or white noise, as well as for the case of arbitrary inputs and feedback.

LPV system identification using CVA can involve the following steps: fitting ARX-LPV models of sufficiently high order and compute the AIC for each order to determine the optimal order; removing the effects of future inputs on future outputs using the optimal ARX-LPV model order to determine the corrected future; doing a CVA between the past and corrected future to determine optimal candidate state estimates, sorting these estimates by their predictive ability, i.e. correlation with future; computing the AIC for each state order to select the optimal state order; and computing SS-LPV models for the optimal state order and other state orders of possible interest.

Examples of a LPV pitch and plunge aeroelastic simulation model has been used extensively in the analysis of LPV models and in designing control systems for LPV models. In its simplest form, this model is a 4-state, 1-input, 2-output system.

In the present example, the wing flutter consists of a 2-degree of freedom rigid body that is conceptually an aircraft wing with a movable trailing-edge flap. The system input is the flap angle β with respect to the wing that is used to control the wing angle of attack α with respect to the free-stream air flow, and the two output measurements are altitude h of the wing center of gravity and wing pitch α. The input α is gaussian random noise to provide persistent excitation insuring identifiability of the model parameters.

The continuous-time differential equations are well documented in the literature. Here, the particular equations from are used:

$$[ \begin{matrix}m & m {x}_{a} b \\ m {x}_{a} b & {I}_{α}\end{matrix} ] [ \begin{matrix}\ddot{h} \\ \ddot{α}\end{matrix} ] + [ \begin{matrix}{c}_{h} & 0 \\ 0 & {c}_{α}\end{matrix} ] [ \begin{matrix}\dot{h} \\ \dot{α}\end{matrix} ] + [ \begin{matrix}{k}_{h} & 0 \\ 0 & {k}_{α}\end{matrix} ] [ \begin{matrix}h \\ α\end{matrix} ] = ρ {U}^{2} b [ \begin{matrix}- {c}_{{l}_{α}} ( α + \frac{1}{U} \dot{h} + ( \frac{1}{2} - a ) \frac{b}{U} \dot{α} ) - {c}_{{l}_{β}} β \\ - {c}_{{m}_{α}} b ( α + \frac{1}{U} \dot{h} + ( \frac{1}{2} - a ) \frac{b}{U} \dot{α} ) - {c}_{{m}_{β}} b β\end{matrix} ] \qquad Equation 55$$

The corresponding parameters are also reprinted in Table 1.

TABLE 1

| Parameter | Value | |
|---|---|---|
| α | −0.6 | |
| b | 0.135 | m |
| m | 12.387 | kg |
| k_{α} | 2.82 | Nm/rad |
| c_{α} | 0.180 | m2kg/s |
| cₗ_{_{α}} | 6.28 | |
| cₗ_{_{β}} | 3.358 | |
| I_{α} | 0.065 | m2kg |
| ρ | 1.225 | kg/m3 |
| x_{α} | 0.2466 | |
| kₕ | 2844.4 | N/m |
| cₕ | 27.43 | kg/s |

| | |
|---|---|
| cₘ_{_{α}} | −0.628 |
| cₘ_{_{β}} | −0.635 |

The operation point of the parameter-varying system is defined by the air density ρ (a function of altitude) in kg/m³ and by the aircraft speed with respect to the air U in m/s.

For the purpose of validating the LPV system identification algorithm, the pitch-plunge wing flutter simulation model was used to simulate discrete-time data with a sample rate of 50 Hz at a variety of operating conditions. The advantage of this LPV model is that for a particular operating condition, the system is a simple 4-state vibrating system. As the operating conditions change, the frequencies and damping of the two modes change, so that it is simple to characterize the system at any operating condition.

For the pitch-plunge flutter model, the two parameter varying functions are rp=[ρU;ρU²]. In the simulation, the air density is kept constant at the value given in Table 1, and the velocity is a ramping input value U=Uₜ=kt that is randomly switched from a positive slope k to a negative slope −k or visa versa. Also the maximum and minimum values of Uₜ is constrained between uₜ₀±δu. In addition, random measurement and/or state noise is also possibly added to the above flutter simulation. The simulated velocity profile of the aircraft is shown in exemplary FIG. 4.

In this example, a simulation case where no noise is added to the simulated output measurements or states to determine the system identification accuracy with no noise present may be considered. In the LPV system identification, for each possible state space order, ord, an LPV state space model of order ord is fitted to the observed simulation data and the Akaike information criteria (AIC) measure of model fit is computed and plotted in exemplary FIG. 5, showing a pitch-plunge state-space model order selection using AIC, no noise case, and a true order of 4. A magnification of the tail beyond the true state order of 4 states is shown in exemplary FIG. 6, a detailed view of a pitch-plunge state-space model order selection showing increasing AIC beyond minimum at order 4, with no noise case. Exemplary FIG. 6 shows the AIC increasing by around 40 per state order that is slightly higher than 30, twice the number of 15 parameters per state order as predicted by the statistical theory. Thus the behavior beyond state order 4 is consistent with the theory of a random walk—that there is no statistically significant additional dynamic structure beyond order 4.

To demonstrate the considerable fidelity of the dynamic SS-LPV model, the multi-step prediction of the outputs plunge h and pitch α are shown respectively in exemplary FIG. 7 (an LPV state-space model 20 step ahead prediction of plunge versus the observed output, no noise case) and exemplary FIG. 8 (an LPV state-space model 20 step ahead prediction of pitch versus the observed output, no noise case) for 20 steps ahead and compared with the observed outputs. In calculating the prediction, the flap angle input β for 20 steps ahead is assumed to be known, and the 20 steps ahead is visually about one cycle of the output signal oscillation. The accuracy of this subset of 400 time samples is typical of the complete data set of 20,000 samples. Over the 400 samples, the aircraft velocity increased by about 8 percent.

The only differences between the observed and predicted output signals are the result of very small differences between the pitch-plunge simulation model and the identified state space model iterated 20 steps ahead. Notice that there is no observable systematic delay in the signal, or under-shoot or over-shoot at the peaks or troughs. The RMS error between the measured output and the 20 steps ahead predictions are about 1 percent of the respective signal RMS. This is quite remarkable since the parameters of the linear dynamic model is changing continually as nonlinear functions of the operating parameters of air density and air speed. Actually, the high precision is the result of estimating only 69 parameters of the 4-state LPV state space model using 20,000 observations. The prediction of 20 steps ahead corresponds to prediction of about one cycle ahead.

Now, consider a simulation case where white measurement noise is added to the simulation to determine its effect. In the LPV system identification, for each possible state space order, ord, an LPV state space model of order ord is fitted to the observed simulation data. The AIC measure of model fit is computed and plotted in exemplary FIG. 9 (a pitch-plunge state-space model order selection using AIC, measurement noise case) where the minimum AIC occurs essentially at state order 6. A magnification of the tail beyond state order of 6 states is shown in exemplary FIG. 10, a detailed view of the pitch-plunge state-space model order selection shows increasing AIC beyond minimum at order 6, measurement noise case. This shows that the AIC increasing by around 23 per state order that is close to twice the number of 15 parameters per state order as predicted by the statistical theory. This behavior is consistent with the theory of a random walk.

Like in the case with no measurement noise in the previous subsection, the 20 steps ahead prediction for the same sector of the dataset is shown in exemplary FIGS. 11 and 12. Exemplary FIG. 11 shows an LPV state-space model 20 step ahead prediction of plunge versus the observed output, measurement noise case and exemplary FIG. 12 shows an LPV state-space model 20 step ahead prediction of pitch versus the observed output, measurement noise case. The differences between the observed output and the output predicted 20 steps ahead by the LPV state space model are primarily the result of additive white measurement noise. It is seen that the 20 steps ahead prediction provides a smoothing of the measurement noise. Notice that there is no observable systematic delay in the signal, or under-shoot or over-shoot at the peaks or troughs. The RMS error between the measured output and the 20 steps ahead predictions are about 10 percent of the respective signal RMS. This is quite remarkable since the parameters of the linear dynamic model are changing continually as nonlinear functions of the operating parameters of air density and air speed. Actually, the high precision is the result of estimating only 99 parameters of the 6-state LPV state space model using 20,000 observations. The prediction of 20 steps ahead corresponds to prediction of about one cycle ahead.

In the first case of no measurement noise described above, the state order chosen is the true state order of 4 states, while in the case of low measurement noise, the minimum occurs close to state order 6. While the input-output state order in the simulation is the true order of 4, the AIC computation determines that in this case it is necessary to use a higher state order of 6 in the LPV state space model to obtain high accuracy prediction of the dynamics in the presence of the measurement noise. An additional advantage of the statistical subspace methods is the possible use of the AIC as order selection criterion.

In another exemplary embodiment, real-time identification and monitoring of automotive engines can be performed using the systems and methods described herein. Some difficulties in previous systems of monitoring automotive engines were mainly due to the nonlinearity of the engine dynamics due to changes in the engine operating conditions. However, as shown herein, many of the powertrain subsystems are well approximated as linear parameter-varying (LPV) systems that are described as time-invariant linear systems with feedback multiplied by operating condition dependent parameters that can be measured or otherwise obtained in real time. The LPV structure has linear dynamics at a fixed operating condition, and has been shown to incorporate much of the known governing laws of physics directly into the structure of the dynamic model.

The subspace method described gives efficient solutions on larger scale problems using well understood linear time-invariant subspace methods. An added benefit is the rigorous determination of the state order of the process that can be valuable for controller implementation. The identification of engine subsystem models in LPV form can have the advantages of greatly improved accuracy, greatly reduced data requirements, and dramatic abilities to extrapolate to conditions not contained in the model fitting data. Use of accurate LPV models in other fields has led to the design of global controllers having guaranteed global stability and margin with improved performance, and monitoring methods to detect changes and faults under operating conditions not previously encountered. Potential issues are significant nonlinearities of some engine models that may benefit from the use of recently developed Quasi-LPV subspace methods. Also, to achieve the potential high identification accuracy may be use of quadruple precision computation for SVD of very large matrices, that is starting to be practical for real-time engine model identification.

The accurate modeling of automotive engines is of great value in model-based engine control and monitoring. Few methods are presently available for general nonlinear and/or parameter- or time-varying systems. Linear parameter-varying (LPV) models discussed herein have the advantage that at a fixed operating point the dynamics are linear, and the LPV model structure reduces the problem to the identification of a linear, time-invariant LTI block. Once this LTI block is determined, the dynamics at any operating point is obtained by scaling various feedback signals by predetermined functions of the operating point. This simple linear (LTI) structure with nonlinear feedback has profound implications for modeling, system identification, monitoring, and control.

The concept of a linear parameter varying-system is a major simplification with wide ranging implications for modeling, system identification, monitoring, and control. The basic concept extends deep into the fundamental laws of physics that are involved in the behavior of the system dynamics.

Many physical structures have simple subsystems that appear to be exceedingly complex when they are operated at many different operating conditions. Recent methods that parameterize the system behavior by a range of operating points can describe the system as a common linear, time-invariant (LTI) subsystem along with nonlinear interactions as functions of the operating conditions. Examples of such systems include vibrating structures, aircraft aerodynamics, chemical processes, etc.

An example is a spring, mass, and damper system with linear dynamics. If this is part of a vehicle traveling down the road, then the response depends to a great degree on the speed of the vehicle. In effect, the forces from the road are scaled by functions of the speed.

More generally, the states and inputs of the LTI subsystem are multiplied by functions of the operating condition and are fed back into the LTI subsystem. The dynamic response remains LTI independent of the speed, but the forces are speed dependent. This is the fundamental structure of LPV systems. In fact the feedback scaling may be governed by the laws of physics expressed as a function of the operating conditions.

This LPV structure is an ideal procedure for extrapolation. In nonlinear dynamic models, a fundamental problem is that there are regions of the state space that are seldom visited by the state trajectory. Without a fundamental method for extrapolation, there will be regions of the state space where the dynamics are poorly approximated. The LPV approach fundamentally circumvents this problem with the LPV model composed of an LTI subsystem involving the dynamics, and feedback involving the changes in operating condition.

The nonlinear system identification approach implemented in the canonical variate analysis (CVA) method discussed herein is based on linear parameter-varying (LPV) model descriptions. The affine state space LPV (SS-LPV) model form of this example may be used because of its parametric parsimony and for its state space structure in control applications. The ARX-LPV (autoregressive input/output) model form used for initial model fitting also plays a role and is discussed first. To simplify the development, stochastic noise in the system is not included in some of the discussions.

The first step in the CVA-LPV procedure is to approximate the LPV process by a high order ARX-LPV model. As it is well know and often done, an LPV dynamic system may be approximated by a high order ARX-LPV system of the form:

$${y}_{t} = {\sum }_{i = 1}^{l} {α}_{i} ( {ρ}_{t - i} ⊗ {y}_{t - i} ) + {\sum }_{i = 0}^{l} {β}_{i} ( {ρ}_{t - i} ⊗ {u}_{t - i} ) + {v}_{t} \qquad Equation 56$$

that gives a linear prediction of the present output yₜ at time t in terms of the past outputs yₜ₋ᵢ and past and possibly present inputs uₜ₋ᵢ, where l is the order of the ARX-LPV process, and vₜ is a white noise process with covariance matrix Σᵥᵥ. The lower limit of the second sum is equal to 1 if the system has no direct coupling between input and output, i.e. β₀=0.

Notice that the time shift t−i in the scheduling functions ρₜ₋ᵢ matches those in the inputs uₜ₋ᵢ and outputs yₜ₋ᵢ in the ARX-LPV equations 56. This is not arbitrary but necessary to avoid the introduction of dynamic dependence in the resulting state space LPV description to be derived from the ARX-LPV model.

Notice that in Equation 56, the parameter-varying functions ρₜ₋ᵢ can be associated, i.e., multiply either with the constant matrix coefficients αᵢ and βᵢ or the data yₜ and uₜ. In the first case, the result is the parameter-varying coefficients αᵢ(ρₜ₋ᵢ [symbol] I_{y}) and βᵢ(ρₜ₋ᵢ [symbol] Iᵤ) respectively to be multiplied by yₜ₋ᵢ and uₜ₋ᵢ, where the dimensions of the identity matrix I_{y} and Iᵤ are respectively the dimensions of y and u. In the second case, since the time shift t−i is the same in all the variables yₜ₋ᵢ, uₜ₋ᵢ and ρₜ₋ᵢ, the augmented data {ρₜ [symbol] yₜ, ρₜ [symbol] uₜ} can be computed once for each time t and used in all subsequent computations.

The association of the PVs with the data allows the direct adaptation of the CVA subspace system identification method for linear time invariant (LTI) systems to LPV systems including all of the computational and numerical advantages of the LTI method. In particular, the ARX-LPV equations become LTI in the augmented data, and calculation of the coefficient estimates for the ARX-LPV model is nearly the same as for an ARX-LTI model using the augmented data. In particular, the estimation of the coefficient matrices α and β from the augmented data involve solving a strictly linear equation.

Consider a linear system where the system matrices are time varying functions of a vector of scheduling parameters ρₜ=[ρₜ(1); ρₜ(2); . . . ; ρₜ(s)], also called parameter-varying (PV) functions, of the form:

xₜ₊₁=A(ρₜ)xₜ+B(ρₜ)uₜ Equation 57

yₜ=C(ρₜ)xₜ+D(ρₜ)uₜ Equation 58

In this example, as usual in much of the literature only LPV systems are considered having affine dependence on the scheduling parameters of the form A(ρₜ)=ρₜ(1)A₁+ . . . +ρₜ(s)Aₛ and similarly for B(ρₜ), C(ρₜ), and D(ρₜ). Here the parameter-varying matrix (Aρₜ) is expressed as a linear combination specified by ρₜ=[ρₜ(1); ρₜ(2); . . . ; ρₜ(s)] of constant matrices A=[A₁ . . . Aₛ], called an affine form and similarly for B, C, and D.

To simplify the discussion, the LPV equations can be written in several simpler forms by associating the scheduling parameters ρₜ with the inputs uₜ and states xₜ analogous to the ARX-LPV case to obtain the form:

$$( \begin{matrix}{x}_{t + 1} \\ {y}_{t}\end{matrix} ) = ( \begin{matrix}A & B \\ C & D\end{matrix} ) ( \begin{matrix}{ρ}_{t} ⊗ {x}_{t} \\ {ρ}_{t} ⊗ {u}_{t}\end{matrix} ) + ( \begin{matrix}{w}_{t} \\ {v}_{t}\end{matrix} ) \qquad Equation 59$$

where [symbol] denotes the Kronecker product M [symbol] N defined for any matrices M and N as the partitioned matrix composed of blocks i,j as (M [symbol] N)_{i,j}=m_{i,j}N with the i,j element of M denoted as m_{i,j}, and [M; N]=(M^{T}N^{T})^{T} denotes stacking the vectors or matrices M and N.

Other available methods for LPV system identification involve iterative nonlinear optimization and nonlinear subspace methods where the computation time grows exponentially with linear growth in the size of the inputs, outputs, state, and scheduling function, i.e. model complexity. These difficulties are avoided by the use of these new LTI subspace methods for identifying LPV systems.

The exemplary data used for gas engine air-fuel ratio modeling may be based on a 6.2L V8 engine with dual-equal cam phasers. Subsystems studied involved LPV models of the intake manifold (IM) and the fuel/lambda path as shown in the block diagram of exemplary FIG. 13. The block diagram has two dynamic LPV blocks (1002 and 1004) interconnected with static nonlinear blocks and followed by a delay block. These dynamic LPV models are discussed in more detail below.

A strategy may be to determine dynamic blocks with LPV structure having measurable input and output variables and known or accurately measurable operating conditions. Also, it may be assumed that the inputs to such blocks have no significant noise. Then using the CVA-LPV systems identification methods, such LPV dynamic input/output blocks are identifiable with sufficient input excitation since these methods are maximum likehood and optimal.

Very high accuracy in parameter estimation is possible using the CVA LPV subspace method, but to realize the accuracy it may require the use of Quadruple (Quad) precision of more than 30 decimal places. Even for the simple aircraft flutter problem of 1-input, 2-outputs, 4-states and 2-scheduling functions, canonical correlations computed in double precision using SVDs of 500 by 20,000 data matrices produced canonical correlations larger than 0.999999999, that retains less than 6 decimal places and often less than 4 places. Such a calculation can be made in 5 minutes or significantly faster, for example 5 seconds using currently available Graphical Processing Units (GPUs) hardware.

A second issue related to combustion engines is potentially large nonlinearities so that the systems are not Strict-LPV but rather Quasi-LPV. The nonlinearities will be shown directly from a widely used state-space engine simulation model. This means that the engine model may actually be bilinear or polynomial which involves Quasi-Scheduling functions that are functions of the dynamic variables of inputs uₜ, outputs yₜ and/or xₜ. The recently developed LPV CVA subspace system identification method was extended to the Quasi-LPV case.

As discussed below, two different methods are used for determining parameter-varying scheduling functions ρₜ. In the first, computation of numerical values of the functions may be done using a nonlinear simulation calculating the time-varying elements of state space coefficient matrices. The second may be the analytical determination of the nonlinear functional form of the coefficients of the difference equations.

A simplified Intake Manifold is shown in exemplary FIG. 13 that includes the electronic throttle as part of the throttle dynamics and flow block. The electronic throttle is driven by an electric motor and is locally controlled by a dedicated controller that may be modeled by a second-order linear system. This additional LPV system is also easily modeled from input throttle Angle set point TA_{SP} to output Throttle Angle α measured by the Throttle Position Sensor TPS.

The input is manifold throttle air-flow \dot{m}ₐₜ, also denoted MAF, and the throttle heat flow \dot{Q}ₑₓₜ is a simple function of Tᵢₘ expression below. With the elements of matrices (A, B, C, D) explicitly expressed as parameter varying (PV) scheduling functions of various temperatures, pressures, mass flows, engine RPM, input throttle command, and sampling time interval. These scheduling functions have considerable nonlinearities. Because of the availability of the Simulink model it may not be necessary to explicitly implement the computation of these scheduling functions since they were implicitly available in the simulation model. Moreover, there is an additional state in the Intake Manifold model for the temperature measurement T_{im,meas}.

As shown in exemplary FIG. 13, the intake manifold open-loop dynamic model is expressed as a LPV state space model of order 3 involving the states of intake manifold pressure Pᵢₘ, intake manifold temperature Tᵢₘ, and measured intake manifold temperature T_{im,meas}, expressed below as difference equations:

$$\begin{matrix}{P}_{im , n + 1} = ( 1 - \frac{κ {V}_{cyl}}{{V}_{im}} {η}_{n} ) {T}_{im , n} + \frac{κ - 1}{{V}_{im}} {T}_{s , n} {\dot{Q}}_{ext} + \frac{κ {R}_{air} {T}_{a , n}}{{V}_{im}} {T}_{s . n} {\dot{m}}_{at , n} & Equation 60 \\ {T}_{im , n + 1} = ( 1 - \frac{κ {V}_{cyl}}{{V}_{im}} {η}_{n} ( 1 - \frac{1}{k} ) ) {T}_{im , n} + \frac{{T}_{im , n} ( κ - 1 ) ( {T}_{s , n} )}{{V}_{im} {P}_{im} ( k )} {\dot{Q}}_{ext} + ( {T}_{im , n} \frac{κ {R}_{air} {T}_{a , n}}{{V}_{im} {P}_{im , n}} - {T}_{im , n}^{2} \frac{{R}_{air}}{{V}_{im} {P}_{im , n}} ) {T}_{s , n} {\dot{m}}_{at , n} & Equation 61 \\ {\dot{Q}}_{ext} = {h}_{1} ( {T}_{coolant} - {T}_{im} ) + {h}_{2} ( {T}_{a} - {T}_{im} ) & Equation 62 \\ {T}_{im , meas , n + 1} = {a}_{T} {T}_{im , meas , n} + {b}_{T} [ {P}_{im , n} ; {T}_{im , n} ] & Equation 63\end{matrix}$$

where \dot{Q}ₑₓₜ is a serogate for Tᵢₘ and express the heat transfer rate from the intake manifold, and the last equation expresses the temperature sensor discrete time dynamic model.

The variables in the state equations are upstream pressure (ambient) Pₐ, upstream temperature (ambient) Tₐ, coolant temperature T_{coolant}, downstream pressure (intake manifold) Pᵢₘ, ratio of specific heats for dry air κ, and ideal gas constant for dry air Rₐᵢᵣ.

Notice the coefficients multiplying the states manifold downstream pressure Pᵢₘ, manifold air temperature Tᵢₘ, measured manifold air temperature T_{im,meas}, and serogate heat transfer rate \dot{Q}ₐₜ are corresponding elements of the A matrix of the state equations. Similarly coefficients multiplying the input throttle mass air-flow \dot{m}ₐₜ, correspond to the B matrix. The coefficients associated with \dot{m}ₐₜ particularly involve the dynamic variables of inputs, outputs, and states.

The strategy in identifying the intake manifold is to obtain a high accuracy input \dot{m}ₐₜ, shown as MAF in FIG. 13. That this is possible has been verified for all but very exceptional situations. The input \dot{m}ₐₜ is obtained as the output of the throttle static nonlinearity with inputs of throttle position sensor (TPS) and feedback of Pᵢₘ as in FIG. 1. The subspace LPV system identification will then obtain an unbiased openloop dynamic model for the intake manifold with outputs Pᵢₘ, Tᵢₘ, and T_{im,meas}.

The Simulink model describes a discrete-time linearized state space model of the throttle/intake manifold that is a time varying 3-state system of the following form:

The continuous-time electronic throttle (ET) model is a linear time-invariant system. The corresponding discrete-time model parameters will vary with engine speed, with the sampling period T_{s,n} related to engine speed Nₙ by T_{s,n}=120(8Nₙ) where Nₙ is in revolutions per minute at the discrete event n.

As shown below, this implies that the electronic throttle discrete-time model is LPV with parameter-varying function T_{s,n}, and to first order and asymptotically for large sample A_{ET,n}=I+F_{ET}T_{s,n} and B_{ET,n}=G_{ET}T_{s,n} where F_{ET} is the continuous time state transition matrix corresponding to A_{ET,n} and similarly for B_{ET,n} and G_{ET}. As a result, the sampling period T_{s,n} is one of the scheduling functions obtained by considering elements of Aₙ.

The output measurements of TPS, \dot{m}ₐₜ, and Tᵢₘ are obtained from direct measurement of the respective states plus measurement noise so that the C matrix is a constant.

The D matrix is zero.

The throttle/intake manifold Simulink model explicitly computes the elements of the discrete-time state transition matrix Aₙ in terms of available operating-point variables. A unique subset of these discussed below specify the Scheduling functions of the LPV model.

The Simulink LPV model can compute each of the elements in the state space model matrix Aₙ which explicitly provides a set of parameter-varying functions of the LPV model. There is some redundancy among all of the possible elements that was determined by computing the correlation matrix among all 25 elements of Aₙ. Table 1 denotes the elements as constant C, duplicate D with high correlation, or unique representative U. The constants C had standard deviation that was 0 to machine precision. Sets of duplicate elements had a correlation coefficient of 0.9908 so the first was taken as the unique representative U and the second as the duplicate D. Elements a_{2,1}, a_{2,4}, a_{3,1}, a_{4,4} had correlation 1 with a_{3,1} taken as the unique representative U, and similarly for a_{5,1}, a_{5,2} with a_{5,1} the unique representative U. The other unique elements were a_{2,2} and a_{3,2} The correlation matrix among all the unique elements in the vector [a_{1,1}; a_{2,2}; a_{3,1}; a_{3,2}; a_{5,1}] is shown in Table 2.

TABLE 1

| | | | | |
|---|---|---|---|---|
| U | D | C | C | C |
| D | U | C | D | C |
| U | U | C | C | C |
| C | C | C | D | C |
| U | D | C | C | C |

TABLE 2

| | α_{1, 1} | α_{2, 2} | α_{3, 1} | α_{3, 2} | α_{5, 1} |
|---|---|---|---|---|---|
| α_{1, 1} | 1.0000 | −0.1481 | −0.3861 | −0.1583 | 0.0647 |
| α_{2, 2} | −0.1481 | 1.0000 | 0.7659 | 0.8664 | 0.7796 |
| α_{3, 1} | −0.3861 | 0.7659 | 1.0000 | 0.9410 | 0.5616 |
| α_{3, 2} | −0.1583 | 0.8664 | 0.9410 | 1.0000 | 0.7639 |
| α_{5, 1} | 0.0647 | 0.7796 | 0.5616 | 0.7639 | 1.0000 |

Parameter varying functions corresponding to the various subsystem dynamics are given in Table 3 for the delay-compensated engine Simulink model.

The complete intake manifold and fuel/lambda subsystem is shown in FIG. 13. The intake manifold provides the air for in-cylinder combustion quantified in the variable cylinder air charge CAC_{s,n} while fuel is provided in the fuel injector and film dynamics block quantified as Fuel Pulse Width FPW_{s/n}. A critical quantity to control is the air-fuel ratio denoted as λ_{s,n} and measured in the exhaust gases prior to the catalytic converter as fuel-air ratio called lambda inverse and denoted λ_{INV,n}. Both fuel injection FPW and measurement of λ_{INV,n} involve substantial delays as indicated in FIG. 13.

To eliminate the delays, the input fuel pulse width FPW to the fuel injector and film dynamics block can be delayed by 6 events relative to the time base T_{s,n} that is expressed as FPW_{s,n-6}. Also notice that due to the 12 event exhaust-gas transport delay, the time base in the Lambda Inverse Sensor Dynamics block is 12 events ahead of the input CFC. Thus by eliminating the delay of 12 in CFC and advancing the time base in the block by 12 events produces the same result except that the output λ_{inv,n+12} is advanced by 12 events. This removes the delays and preserves the dynamics within each block. In addition, the parameter varying functions entering the lambda inverse sensor dynamics block need to be advanced by 12 events as well.

The removal of delays is a major simplification of the system identification problem when using subspace system identification methods. Since delays of 6 plus 12 events is a total of 18 events, the delays increase the state order from a total of 5 states without delays to a total of 23 states with delays. Computation time using subspace identification methods tend to increase as the cube of the state order.

Using the above simplification to remove the pure delays in FPW and λ allows the Fuel-Lambda path to be expressed as the 2-state system:

$$\begin{matrix} {m}_{w , n + 1} = ( 1 - \frac{{T}_{s , n}}{{τ}_{n}} ) {m}_{w , n} + {X}_{n} {k}_{fi , n - 6} {FPW}_{off , n} & Equation 64 \\ {λ}_{INV , n + 13} = ( 1 - \frac{{T}_{s , n + 12}}{{τ}_{λ inv , n + 12}} ) {λ}_{INV , n + 12} + \frac{{T}_{s , n + 12}}{{τ}_{λ inv , n + 12}} \frac{A {F}_{stoich}}{C A {C}_{n}} [ \frac{{T}_{s , n}}{{τ}_{n}} {m}_{w , n} + ( 1 - {X}_{n} ) {k}_{fi , n} {FPW}_{off , n - 6} ] & Equation 65\end{matrix}$$

The input in this 2-state Fuel-Lambda Path subsystem is the offset in FPW, FPW_{off,n}, the output is the measured Lambda inverse, λ_{INV,n+12}, and the states are mass of the fuel wall, m_{w,n} and λ_{INV,n+12}. The parameters τ and X are operating condition dependent parameters of the process.

The parameter varying functions of the 2-state Fuel-Lambda model of equations 64 and 65 are given in Table 3. It may be noticed that PV functions in rows (3) and (4) of the Table involve products of factors with differing time delays. This may seem unusual, but is rigorously developed here in the context of a delayed LPV dynamic system. Thus, a LPV representation can also be a powerful tool for removing delays from a discrete-time delayed LPV system and reduce the state order considerably. Finally, following the output λ_{INV,n+12} of this system with a delay of 12 events produces the delayed output λ_{INV,n}.

TABLE 3

| Row Scheduling Function | Delay Variable |
|---|---|
| (1) Xₙk_{fi,n} | |
| $( 2 ) ( 1 - \frac{{T}_{s , n}}{{τ}_{n}} )$ | |
| $( 3 ) \frac{{T}_{s , n + 12}}{{τ}_{λ inv , n + 12}} \frac{{AF}_{stoich}}{{CAC}_{n}} ( 1 - {X}_{n} ) {k}_{fi , n}$ | (FPW − 0)_{fi,n-6} |
| $( 4 ) \frac{{T}_{s , n + 12}}{{τ}_{λ inv , n + 12}} \frac{{AF}_{stoich}}{{CAC}_{n}} \frac{{T}_{s , n}}{{τ}_{n}}$ | λ_{INV,n+12} |
| $( 5 ) ( 1 - \frac{{T}_{s , n + 12}}{{τ}_{λ inv , n + 12}} )$ | |

In this example, the application of a new method for system identification of LPV systems to modeling automotive engines from measured data is presented. Past methods for LPV system identification have only been applied to systems with few dynamic variables and few scheduling functions. The LTI subspace identification methods potentially scale to much larger and complex LPV and Quasi-LPV systems.

A detailed study of high fidelity LPV engine Simulink models was also provided with respect to these exemplary embodiments. The two subsystems discussed were the intake manifold and the Fuel-Lambda path. Two different approaches were taken, one involving the use of the Simulink model to compute the scheduling functions, and the other using directly the analytic expressions underlying the Simulink model.

There are two major issues that are characteristic to some LPV model types and to some engine subsystems. The intake manifold is quite nonlinear which means the scheduling functions are functions of the dynamic variables of inputs, outputs, and/or states rather than linear functions of known exogenous operating condition variables. This can potentially introduce large estimation error into the identification procedure. The other issue is the extreme high accuracy that may potentially be possible since the scheduling functions are encoded with considerable information about the highly complex engine behavior. As a result, some engine parameters can potentially be estimated with very high accuracy. But to take advantage of this may require quadruple precision computation.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method of forming a dynamic model for the behavior of machines from available data, comprising:
obtaining operating data from a machine in operation;
fitting an autoregressive (ARX) linear parameter varying (LPV) model for at least one of orders and states of a machine based on the operating data collected from the machine in operation;
removing effects of future inputs on future outputs from the model;
determining a corrected future for the model;
performing, with a processor, a weighted singular value decomposition (SVD) between an augmented past and the corrected future;
choosing a state order;
fitting state space (SS) equation coefficient estimates;
fitting noise coefficient estimates; and
generating a dynamic model of machine behavior.

2. The method of forming a dynamic model for the behavior of machines from available data of claim 1, wherein the at least one of orders and states are chosen using a computed Akaike information criterion (AIC).

3. The method of forming a dynamic model for the behavior of machines from available data of claim 1, wherein the weighted singular value decomposition is performed with a canonical variate analysis (CVA).

4. The method of forming a dynamic model for the behavior of machines from available data of claim 1, wherein the state order is chosen using Akaike information criterion.

5. A method that transforms a set of measured data from a machine in operation into a dynamic model for behavior of the machine, comprising:
a plurality of data collection devices that collect and transmit data from a machine in operation to a database;
an optimal order generated by an autoregressive (ARX) linear parameter varying (LPV) model that computes an Akaike information criterion (AIC) for each order or data in the database;
a processor that performs a canonical variate analysis (CVA) between the collected data in the database and corrected future data;
a series of optimal candidate state estimates determined by the CVA;
a processor that sorts the optimal candidate state estimates by predictive ability of the optimal candidate state estimates;
a processor that computes the AIC for each state order to select an optimal state order and computes a state space LPV model for at least the optimal state order.

6. The system of claim 5, wherein the machine is a combustion engine.

7. The system of claim 5, wherein the machine is an aircraft.

8. The system of claim 5, wherein the machine is a vibrating structure.

9. The system of claim 5, wherein the machine is an automobile suspension.
